(19) United States
(12) Patent Application Publication
(10) Pub. No.: US 2026/0120178 A1
(43) Pub. Date: Apr. 30, 2026

(54) MANAGING INCOME STREAMS USING A DISTRIBUTED LEDGER AND SOULBOUND TOKENS

(71) Applicant: TEACHERS INSURANCE AND ANNUITY ASSOCIATION OF AMERICA, New York, NY (US)

(72) Inventors: Sastry Vsm Durvasula, Phoenix, AZ (US); Swatee Singh, Livingston, NJ (US); Rares Ioan Almasan, Paradise Valley, AZ (US); Vamsi Pola, Concord, NC (US)

(21) Appl. No.: 18/928,398

(22) Filed: Oct. 28, 2024

(51) Int. Cl. G06Q 40/02; G06Q 20/36; G06Q 20/38; G06Q 20/40

(52) U.S. Cl. CPC G06Q 40/02; G06Q 20/36; G06Q 20/389; G06Q 20/405

(57) ABSTRACT

Systems and methods for managing income streams using a distributed ledger are provided. The system may generate at least one transaction including data to: (i) generate at least one soulbound token (SBT) on the distributed ledger, (ii) deposit the at least one SBT into a digital wallet on the distributed ledger associated with a recipient of the income, and (iii) for the each SBT, generate at least one associated smart contract on the distributed ledger. The SBT may be nontransferable and may correspond to an income stream providing an income from an income source. The smart may be configured to automatically distribute at least a portion of the income into the digital wallet. The system may provide the at least one transaction to a node of the distributed ledger for validation and recording of the at least one transaction on the distributed ledger.

### CROSS-REFERENCE TO RELATED APPLICATIONS

This application is related to co-pending U.S. patent application Ser. No. ______ (Attorney Docket No. 33802/70228B) entitled “MANAGING INCOME STREAMS USING A DISTRIBUTED LEDGER AND SOULBOUND TOKENS” and filed concurrently herewith, the entire contents of which is hereby expressly incorporated by reference.

### FIELD OF THE INVENTION

The present disclosure generally relates to income management, and more particularly, systems and methods to manage an income stream using a distributed ledger.

### BACKGROUND

Individuals, for example retirees, often have multiple income streams, such as pensions, social security benefits, personal investments, etc., from which they receive income. A traditional income management system lacks the ability to manage multiple, disparate income streams, making it difficult for the income recipient to gain a clear and comprehensive understanding of their financial situation. Accordingly, the income recipient must access multiple income management systems to manage each of their income streams, which can be complex, time-consuming, and overwhelming.

Additional shortcomings of traditional income management systems may include an inability for the user to tailor automatic income distributions from their income streams in a personalized manner; the inability to detect fraud, data breaches, and/or other unauthorized access to sensitive financial information; increased income management costs due to manual income stream management by intermediaries; the inability to receive personalized, on-demand financial advice and services from a knowledgeable source to optimize management of one or more income streams in a dynamic manner; and the inability to distribute income for specific use cases (investments, bill pay, taxes etc.) based upon rules and/or distribution triggering events, among other shortcomings as described herein.

The systems and methods disclosed herein provide solutions to these problems and may provide solutions to the ineffectiveness, insecurities, difficulties, inefficiencies, encumbrances, and/or other drawbacks of conventional techniques.

### SUMMARY

In some embodiments, a system for managing income streams using a distributed ledger includes: one or more processors, and one or more memories having stored thereon a set of computer-executable instructions that, when executed, cause the system to: (1) generate at least one transaction including data to: (i) generate at least one soulbound token (soulbound token) on the distributed ledger, wherein each soulbound token of the at least one soulbound token is nontransferable and corresponds to an income stream providing an income from an income source, (ii) deposit the at least one soulbound token into a digital wallet on the distributed ledger associated with a recipient of the income, and (iii) for the each soulbound token, generate at least one associated smart contract on the distributed ledger, wherein each smart contract of the at least one smart contract is configured to automatically distribute at least a portion of the income, from the income stream of a corresponding soulbound token, into the digital wallet; and (2) provide the at least one transaction to a node of the distributed ledger for validation and recording of the at least one transaction on the distributed ledger, to perform at least one of: generating the at least one soulbound token on the distributed ledger, depositing the at least one soulbound token into the digital wallet on the distributed ledger, or generating the at least one smart contract on the distributed ledger. The system may include additional, less, or alternate functionality, including that discussed elsewhere herein.

In other embodiments, a computer-implemented method for managing income streams using a distributed ledger includes (1) generating, by one or more processors, at least one transaction including data to: (i) generate at least one soulbound token (soulbound token) on the distributed ledger, wherein each soulbound token of the at least one soulbound token is nontransferable and corresponds to an income stream providing an income from an income source, (ii) deposit the at least one soulbound token into a digital wallet on the distributed ledger associated with a recipient of the income, and (iii) for the each soulbound token, generate at least one associated smart contract on the distributed ledger, wherein each smart contract of the at least one smart contract is configured to automatically distribute at least a portion of the income, from the income stream of a corresponding soulbound token, into the digital wallet; and (2) providing, by the one or more processors, the at least one transaction to a node of the distributed ledger for validation and recording of the at least one transaction on the distributed ledger, to perform at least one of: generating the at least one soulbound token on the distributed ledger, depositing the at least one soulbound token into the digital wallet on the distributed ledger, or generating the at least one smart contract on the distributed ledger. The method may include additional, fewer, or alternate actions, including those discussed elsewhere herein.

In yet other embodiments, a non-transitory computer-readable medium storing processor-executable instructions that, when executed by one or more processors, cause the one or more processors to at least: (1) generate at least one transaction including data to: (i) generate at least one soulbound token (soulbound token) on a distributed ledger, wherein each soulbound token of the at least one soulbound token is nontransferable and corresponds to an income stream providing an income from an income source, (ii) deposit the at least one soulbound token into a digital wallet on the distributed ledger associated with a recipient of the income, and (iii) for the each soulbound token, generate at least one associated smart contract on the distributed ledger, wherein each smart contract of the at least one smart contract is configured to automatically distribute at least a portion of the income, from the income stream of a corresponding soulbound token, into the digital wallet; and (2) provide the at least one transaction to a node of the distributed ledger for validation and recording of the at least one transaction on the distributed ledger, to perform at least one of: generating the at least one soulbound token on the distributed ledger, depositing the at least one soulbound token into the digital wallet on the distributed ledger, or generating the at least one smart contract on the distributed ledger. The instructions may direct additional, less, or alternate functionality, including that discussed elsewhere herein.

In some embodiments, a system for managing income streams using machine learning may include one or more processors, and one or more memories storing a machine learning model that is trained using historical financial data to manage an income stream recorded as a non-transferable soul-based token on a distributed ledger. The one or more memories may further store a set of computer-executable instructions that, when executed, cause the system to: (i) receive, from a computing device, distribution criteria for distributing at least a portion of income received from the income stream to one or more distribution recipients; (2) obtain soulbound token information associated with the soulbound token; (3) analyze, by the machine learning model, the distribution criteria and the soulbound token information to generate one or more distribution insights; and (4) generate, by the machine learning model, one or more distribution schemes associated with distributing at least the portion of the income to the one or more distribution recipients, based upon the one or more distribution insights. The system may include additional, less, or alternate functionality, including that discussed elsewhere herein.

In other embodiments, a computer-implemented method for managing income streams using machine learning may include: (i) receiving, by one or more processors from a computing device, distribution criteria for distributing at least a portion of income received from an income stream to one or more distribution recipients; (ii) obtaining, by the one or more processors, soulbound token information associated with a soulbound token recorded on a distributed ledger and corresponding to the income stream; (iii) analyzing, by a machine learning model trained using historical financial data to manage the income stream, the distribution criteria and the soulbound token information to generate one or more distribution insights; and (iv) generating, by the machine learning model, one or more distribution schemes associated with distributing at least the portion of the income to the one or more distribution recipients, based upon the one or more distribution insights. The method may include additional, fewer, or alternate actions, including those discussed elsewhere herein.

In yet other embodiments, a non-transitory computer-readable medium storing processor-executable instructions that, when executed by one or more processors, may cause the one or more processors to at least: (i) receive, from a computing device, distribution criteria for distributing at least a portion of income received from an income stream to one or more distribution recipients; (ii) obtain soulbound token soulbound token information associated with a soulbound token recorded on a distributed ledger and corresponding to the income stream; (iii) analyze, by a machine learning model trained using historical financial data to manage the income stream, the distribution criteria and the soulbound token information to generate one or more distribution insights; and (iv) generate, by the machine learning model, one or more distribution schemes associated with distributing at least the portion of the income to the one or more distribution recipients, based upon the one or more distribution insights. The instructions may direct additional, less, or alternate functionality, including that discussed elsewhere herein.

Additional, alternate and/or fewer actions, steps, features and/or functionality may be included in some aspects and/or embodiments, including those described elsewhere herein.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an example computing environment for managing income streams using a distributed ledger and machine learning, according to some embodiments.

FIG. 2 depicts a block diagram of example network nodes and an example distributed ledger, according to some embodiments.

FIG. 3 depicts a block diagram of example network nodes and an example transaction flow on a distributed ledger network for managing income streams, according to some embodiments.

FIG. 4 depicts a block diagram of example components of a network node on a distributed ledger network for managing income streams, according to some embodiments.

FIG. 5 depicts a flow diagram for example training and operation of an example machine learning models, according to some embodiments.

FIG. 6 depicts an example combined block and logic diagram for example training of an example machine learning chatbot, according to some embodiments.

FIG. 7 depicts a flow diagram of an example workflow for income stream onboarding and income distribution, according to some embodiments.

FIG. 8 depicts an example income stream dashboard, according to some embodiments.

FIG. 9A depicts an example income management platform dashboard for providing income distribution criteria, according to some embodiments.

FIG. 9B depicts an example income management platform dashboard for providing income distribution insights, according to some embodiments.

FIG. 9C depicts an example income management platform dashboard for providing income distribution schemes, according to some embodiments.

FIG. 10 depicts a flow diagram of an example computer-implemented method for managing income streams using a distributed ledger, according to some embodiments.

FIG. 11 depicts a flow diagram of an example computer-implemented method for managing income streams using machine learning, according to some embodiments.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, managing an income stream using a distributed ledger and/or machine learning. In accordance with the above, and with the disclosure herein, the present disclosure includes improvements in computer functionality and/or improvements to other technologies at least because the claims recite, for example, generating a soulbound token (also referred to herein as “SBT”) corresponding to an income stream providing an income from an income source to an income recipient, and recording the soulbound token on a distributed ledger via one or more transactions to manage the income stream. The soulbound token is a digital token residing on a distributed ledger, and may be defined according to a particular standard (e.g., defined by the ERC-5484 standard). The soulbound token is configured to be “soulbound” in nature, that is once the soulbound token is transferred to a recipient, such as deposited in the digital wallet of a recipient on the distributed ledger as provided by the disclosed techniques, it may not be transferred to another party/digital wallet, and serves as a tamper-proof, immutable record of ownership of the corresponding income stream by the recipient. Managing the income stream via the soulbound token on the distributed ledgers advantageously improves the technology of digital income steam management by providing the income recipient control over onboarding their income streams as soulbound tokens, and increased security over the income streams as the soulbound tokens will remain bound to the income recipient's identity and cannot be claimed, transferred, and/or modified by an unauthorized party.

The systems and methods may include generating at least one smart contract on the distributed ledger configured to automatically distribute at least a portion of the income, from the income stream corresponding to the soulbound token, into the digital wallet. The systems and methods further include recording the soulbound token on a distributed ledger to manage the income stream via one or more transactions. The smart contracts improve the technology of digital income steam management at least by enabling the income recipient to tailor their income flows from the income streams to their precise needs via the smart contracts, including the ability to create and/or adjust smart contract condition triggers, for example as their financial goals or circumstances evolve. Moreover, the smart contracts streamline and automate income distribution, reducing administrative costs by minimizing the need for intermediaries to manually intervene to carry out such distributions.

Advantageously, at least through the creation and use of soulbound tokens and smart contracts, an income recipient or other party (e.g., a financial service providing and/or managing the income streams) is able to view and manage multiple income streams in one place (i.e., the distributed ledger), improving the technological field of digital income stream management. Moreover, using the distributed ledger, which inherently records all transactions associated with the soulbound tokens and smart contracts on the distributed ledger via nodes, as the medium to manage income streams provides transparency and auditability (e.g., for detection of fraud, data breaches, or other unauthorized access) provides the income recipient further security and control over their income streams that traditional income management systems lack.

The disclosed systems and methods further may include receiving distribution criteria (e.g., income distribution rules, recipients, distribution characteristics) from a user, such as the income recipient, for distributing at least a portion of income received from the income stream to one or more distribution recipients. Allowing the user to configure automatic income distributions from income streams via user-provided distribution criteria provides another layer of control and customizations of income distribution over one or more income streams not present in traditional income management systems. Allowing the user to define rules and other criteria to automate income deployment strategies and manage income streams in a nuanced and personalized manner further improves the technological field of digital income stream management.

The systems and methods further may include analyzing the distribution criteria and information associated with the soulbound token (e.g., characteristics of the soulbound token, the corresponding income stream, the associated smart contracts, etc.) using a machine learning model trained with financial knowledge to generate one or more distribution insights, such as income stream analytics (e.g., income stream sources, income distributions, digital wallet balance), income forecasting, financial goal modeling, financial advice, income distribution recommendations, etc. The model may also be trained to generate income distribution schemes for distributing the income based upon the distribution insights. Using a machine learning model trained to manage income streams via the generation of distribution schemes and distribution insights provides intelligent optimization of income from income streams (e.g., to address the income recipient's personal needs and financial goals). The technological improvements further include the ability to provide valuable insights, for one or more income streams, by the machine learning model to the income recipient that are not otherwise available from traditional income management platforms having limited knowledge of the income recipient's financial situation and income streams. These techniques can be applied to manage multiple (e.g., tens, hundreds, thousands) income streams from a variety of income source for a number of users by improving the overall ability of a system to parse and handle multiple threads, thereby improving the overall resource usage, bandwidth, and processing time required to track such streams.

The present disclosure further describes improvements in the functioning of the computer system when utilizing soulbound tokens and smart contracts to represent an income stream on a distributed ledger, and distribute income therefrom. The functioning of the computer itself is improved at least because multiple income management systems to manage multiple income streams and implement their associated income distributions are not required, as such processing systems require increased memory storage and/or execution compute cycles when managing income streams via disparate systems as compared to the systems, devices, and/or platforms providing the income stream management via a single medium (the distributed ledger) to automate distributions using soulbound tokens and smart contracts. The present disclosure includes specific features other than what is well-understood, routine, conventional activity in the field, and/or otherwise adds unconventional steps that confine the disclosure to a particular useful application, e.g., systems and methods for managing income streams using a distributed ledger and machine learning.

As used herein, the artificial intelligence (AI) may refer to one or more technologies, such as but not limited to, machine learning (ML), (recurrent) neural networks, generative adversarial networks, and/or AI/ML models, that can perform tasks which typically require human intelligence, for example learning, reasoning, problem-solving, perception, language understanding, generating content, etc. Accordingly, “artificial intelligence” and/or “AI” may be used interchangeably with “machine learning,” “ML,” and/or terminology for similar technologies. In at least some embodiments, generative AI may be used, e.g., to generate blockchain transactions, soulbound and/or smart contact code, to generate chatbot responses, etc., thereby improving the technological field of digital income stream management as compared to non-generative AI by improving responsiveness, accuracy of the model, and ability to iterate on responses, saving resources and processing time.

### Example Computing Environment

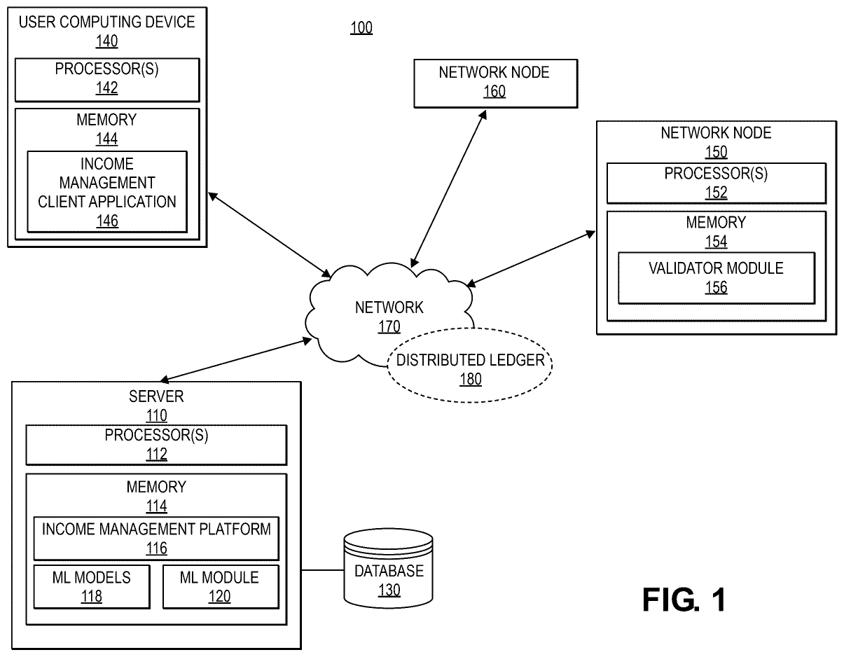

FIG. 1 depicts a block diagram of an example computing environment 100 for managing income streams using a distributed ledger and/or machine learning. The example computing environment 100 may include, in some embodiments, a computing device 110, a user computing device 140, and network nodes 150, 160, which may be communicatively connected through a network 170 as described below. It will be understood that the example computing environment 100 may include additional, fewer, and/or alternate components.

In some embodiments, the computing device 110 may be operated by, and/or associated with, a company, business, organization, etc., (collectively “company”) associated with income management. The company may be a provider of financial services. In a first example, the company may administers retirement programs, such as retirement planning, receiving and distributing funds associated with retirement savings and investment, and the like. In a second example, the company may be a hedge fund providing investment advice and investment services for stocks, bonds, currencies, commodities, derivatives, and/or other financial instruments. In a third example, the company may be a provider of services, financial or otherwise, having an accounting or similar department that receives funds (e.g., from its customers) and distributes funds (e.g., to its vendors).

In some such embodiments, the user computing device 140 may be operated by, and/or associated with, a user that is associated with the company. In the first example above, the user may be a retiree that is a customer of the company administering retirement programs. In the second example above, the user may be an investor in the hedge fund. In the third example, the user may be an employee of the service provider, a customer of the service provider, or a vendor of the service provider.

According to some embodiments, the computing device 110 may perform at least some of the functionalities and techniques disclosed herein, such as generating income distribution insights, generating income distribution schemes, training models, generating and/or recording soulbound tokens on the distributed ledger, generating and/or recording smart contracts on the distributed ledger, and/or other suitable functionalities for managing income streams. The computing device 110 may include one or more servers that are co-located and/or remotely distributed. The computing device 110 may be part of a cloud network or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment.

The example computing device 110 includes a processor 112. The processor 112 may include one or more processors, such as central processing units (CPUs), graphics processing units (GPUs), and/or any other suitable processor. The processor 112 is communicatively coupled to and/or otherwise accessed by a memory 114 via a computer bus (not depicted) to create, read, update, transmit, delete, or otherwise access or interact with the data, data packets, or otherwise electronic signals to and from the processor 112 and the memory 114, for example in order to implement or perform the machine-readable instructions, methods, processes, elements, or limitations, as illustrated, depicted, or described for the various flowcharts, illustrations, diagrams, figures, and/or other disclosure herein. The processor 112 interfaces with the memory 114 via a computer bus to execute an operating system and/or computing instructions stored in the memory 114, and/or to access other services, components, etc. For example, the processor 112 may interface with the memory 114 via the computer bus to create, read, update, delete, or otherwise access or interact with the data stored in the memory 114 and/or the database 130 to manage income streams.

The memory 114 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc. The memory 114 stores machine-readable instructions executable by the processor 112, which may include an operating system (e.g., Microsoft Windows, Linux, UNIX, etc.) capable of facilitating the functionalities, applications, methods, or other software.

The memory 114 may store an income management platform 116 application for managing income streams, as described in further detail below. In at least some aspects, a user may access the income management platform 116 via the computing device 110 (e.g., via a user interface of the computing device), the user computing device 140 (e.g., via the network 170), and/or other suitable device.

The computing device 110 may include, and/or have access to (e.g., via network 170), a database 130. The database 130 may include one or more databases that are co-located or remotely distributed. The database 130 may be or include a relational database, such as Oracle, DB2, MySQL, a NoSQL based database, such as MongoDB, or another suitable database. The database 130 may store data and/or datasets discussed herein, such as machine learning models, training datasets used to train and/or operate one or more machine learning models, code for soulbound tokens and/or smart contracts, soulbound token information, distribution criteria, and so on. A dataset may include one or more types of data, records, files, etc. The terms “data” and “dataset” may be used interchangeably herein.

The memory 114 may store one or more machine learning models 118, discussed briefly here and in more detail below. The machine learning models 118 may be referred to at times herein as “models” or “algorithms.” In some embodiments, the machine learning models 118 include a machine learning model that is trained to manage an income stream using training data including historical financial data, such as historical income stream information, historical soulbound token information, historical distribution criteria, historical distribution insights, historical income distribution schemes, or other suitable training data. The machine learning model may be trained to generate one or more distribution insights based upon analyzing criteria for distributing at least a portion of income received from the income stream to one or more distribution recipients, soulbound token information associated with the income stream recorded as a soulbound token on a distributed ledger, and/or other suitable data. The machine learning model may be trained to generate one or more distribution schemes associated with distributing at least the portion of the income to the one or more distribution recipients, based at least upon the one or more distribution insights.

In some aspects, the machine learning model may be, and/or include, a machine learning chatbot trained to receive user requests (e.g., via the user computing device 140) and provide responses thereto, for example in a conversational manner using natural language.

In some embodiments, the machine learning models 118 may include a plurality of fine-tuned machine learning models. In such embodiments, the machine learning model may be retrained/fine-tuned using a plurality of training datasets associated with a plurality of financial domains, to generate the plurality of fine-tuned machine learning models (e.g., BERT models). The fine-tuned machine learning models may be trained to generate one or more financial domain insights associated with the respective plurality of financial domains (e.g., 401k, Roth investment retirement accounts, equities, stocks, etc.). Such financial domain insights associated with managing the income stream may include 401k investment suggestions based upon income streams via a fine-tuned model trained in the 401k financial domain, financial goal modeling of equities via a fine-tuned model trained in equities, etc.

The memory 114 may store a plurality of computing modules, implemented as respective sets of computer-executable instructions, such as a machine learning module 120. The machine learning module 120 may comprise a set of computer-executable instructions implementing machine learning loading, configuration, initialization, and/or operation functionality. In some embodiments, at least one of a plurality of machine learning methods and algorithms is applied by the machine learning module 120, where the machine learning methods and algorithms may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented machine learning methods and algorithms are directed toward at least one of a plurality of categorizations of machine learning, such as supervised learning, unsupervised learning, and reinforcement learning. In some aspects, the machine learning based algorithms may be included as a library or package executed on the server(s) 110. For example, libraries may include the TensorFlow based library, the PyTorch library, and/or the scikit-learn Python library.

In operation, the machine learning module 120 may access the memory 114, the database 130, and/or any other data source, for training data suitable to generate one or more machine learning models, such as the machine learning models 118. The training data may be sample data with assigned relevant and comprehensive labels (classes or tags) used to fit the parameters (weights) of a machine learning model with the goal of training it by example. In some aspects, once an appropriate machine learning model is trained and validated to provide accurate predictions and/or responses, the trained machine learning model may be loaded into the machine learning module 120 at runtime to process input data and generate output data. Once trained, the one or more trained machine learning models may be operated in inference mode, whereupon when provided with de novo input that the trained machine learning model has not previously been provided, the trained machine learning model may output one or more predictions, classifications, etc., as described herein. The machine learning module 120 may include instructions for storing the trained machine learning models (e.g., in the memory 114 as machine learning models 118, in the database 130, etc.). Various embodiments, examples, and/or aspects disclosed herein may include training and generating one or more machine learning models for the computing device 110 to load at runtime. Additionally, or alternatively, one or more appropriately trained machine learning models may already exist (e.g., in the memory 114, the database 130) such that the computing device 110 may load an existing trained machine learning model at runtime. In some embodiments, computing device 110 may retrain, fine-tune, update and/or otherwise alter an existing machine learning model before and/or after loading the model at runtime.

The computing environment 100 may include the user computing device 140, for example for a user (e.g., a retirement services customer, a retirement services agent) to manage their income streams. The user computing device 140 may include a processor 142 and a memory 144, such as the processor 112 and memory 114. The memory 144 may store an income management client application 146 to manage one or more income streams, e.g., to generate one or more distribution schemes for the income stream, as described in further detail below. In some examples, the income management client application 146 may be supported by, and/or communicatively coupled to (e.g., via the network 170), the income management platform 116 to provide various functionalities for managing income streams as described herein. In some examples, the income management client application 146 may provide various functionalities for managing income streams similar to those provided by the income management platform 116 without necessarily being communicatively coupled to the income management platform 116, for example the management client application 146 operating as a stand-alone application.

The computing environment may include the network nodes 150, 160, which may maintain the distributed ledger 180. The network nodes 150, 160 may each include a processor 152 (e.g., the processor 112) and a memory 154 (e.g., the memory 114), and/or other components not shown in FIG. 1 (e.g., an input/output (I/O) circuit, a network interface), all of which may be interconnected via an address/data bus. In some embodiments, the computing device 110 and/or the user computing device 140 may be configured as, or include, one of the network nodes 150, 160 on the distributed ledger 180 (e.g., the memory 114 of the computing device 110 may include a validator module 156, etc.).

The memory 154 may store various applications for execution by the processor 152. For example, a user interface application may provide a user interface for the network node 150, which may, for example, allow the system administrator to configure, troubleshoot, and/or test various aspects of the node's operation.

The memory 154 may store, for example, instructions executable on the processor 152 for the validator module 156. The validator module 156 may validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supplies a proof-of-identity such that only approved entities may originate changes to the chain. Consensus rules may include a mechanism to determine the order in which new blocks are added to the chain (e.g., through a proof-of-work system, proof-of-stake, etc.). The validator module 156 may append distributed ledger data to the distributed ledger 180, if the distributed ledger data satisfies the consensus rules, by generating a new block of validated transactions to include in the distributed ledger 180, and/or by broadcasting a block of transactions to other network nodes. Otherwise, the validator module 156 may disregard any distributed ledger data that does not satisfy the consensus rules, and the distributed ledger data is not propagated to other network nodes.

The network nodes 150, 160 of the distributed ledger 180 may be configured to maintain a state database and execute code in smart contracts deployed by network participants. For example, one or more smart contracts on the distributed ledger 180 may include data for minting the soulbound token, depositing the soulbound token into a digital wallet, transferring income from the income stream corresponding to the soulbound token into and/or out of the digital wallet, and/or other such operations in accordance with the techniques discussed herein. The smart contracts may contain conditions, represented in the state database, to enable or restrict performance of such actions.

The computing device 110, the user computing device 140, and/or the network nodes 150, 160 may communicate with each other via the network 170. The network 170 may comprise any suitable network or networks, including a local area network (LAN), wide area network (WAN), the Internet, and/or any combination thereof. For example, the network 170 may include a wireless cellular service (e.g., 4G service, 5G service, 6G service, etc.). In some aspects, the network 170 may comprise a cellular base station, such as cell tower(s), communicating to one or more components of the computing environment 100 via wired/wireless communications based upon any one or more of various mobile phone standards, including by non-limiting example NMT, GSM, CDMA, UMTS, LTE, 5G, 6G, or the like. Additionally, or alternatively, the network 170 may comprise one or more routers, wireless switches, or other such wireless connection points communicating to the components of the computing environment 100 via wireless communications based upon any one or more of various wireless standards, including by non-limiting example IEEE 802.11a/ac/ax/b/c/g/n (Wi-Fi), Bluetooth, and/or the like.

Furthermore, although the example computing environment 100 illustrates only certain number(s) of each of the components, any number of the example components are contemplated (e.g., any number of network nodes, user computing devices, servers, databases, etc.).

### Example Distributed Ledgers for Managing Income Streams

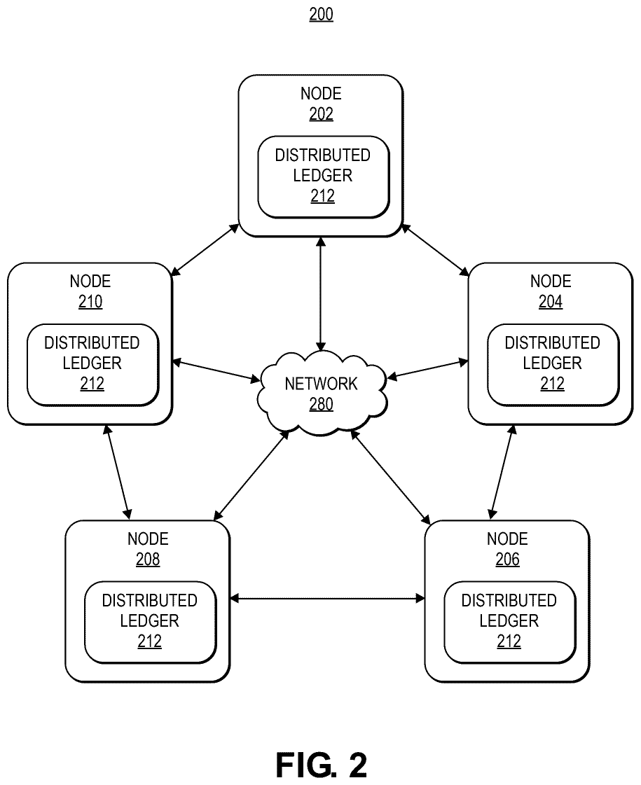

FIG. 2 depicts a block diagram of an example distributed ledger system 200 for managing income streams. The distributed ledger system 200 may include a distributed ledger 212 (e.g., the distributed ledger 180 having one or more distributed ledger layers) and a plurality of nodes 202, 204, 206, 208, and 210 (e.g., the nodes 150, 160). It will be understood that the example distributed ledger system 200 may include additional, fewer, and/or alternate components.

Each node maintains a copy of the distributed ledger 212. As changes are made to the distributed ledger 212, each node 202-210 receives a change (e.g., a transaction) via the network 280 (e.g., the network 170) and updates a respective copy of the distributed ledger 212. A consensus mechanism (e.g., the validator module 156) may be used by the nodes 202, 204, 206, 208, 210 in the distributed ledger system 200 to decide whether to make received changes to the distributed ledger 212. Each node in the system therefore stores and/or maintains a respective copy of the distributed ledger 212, which is identical to every other copy of the distributed ledger 212 stored by the other nodes. The distributed ledger system 200 may be more robust than a central authority database system because of the distributed ledger's decentralized nature. As such, there is no single point of failure on the distributed ledger system 200 as there would be in a centralized system.

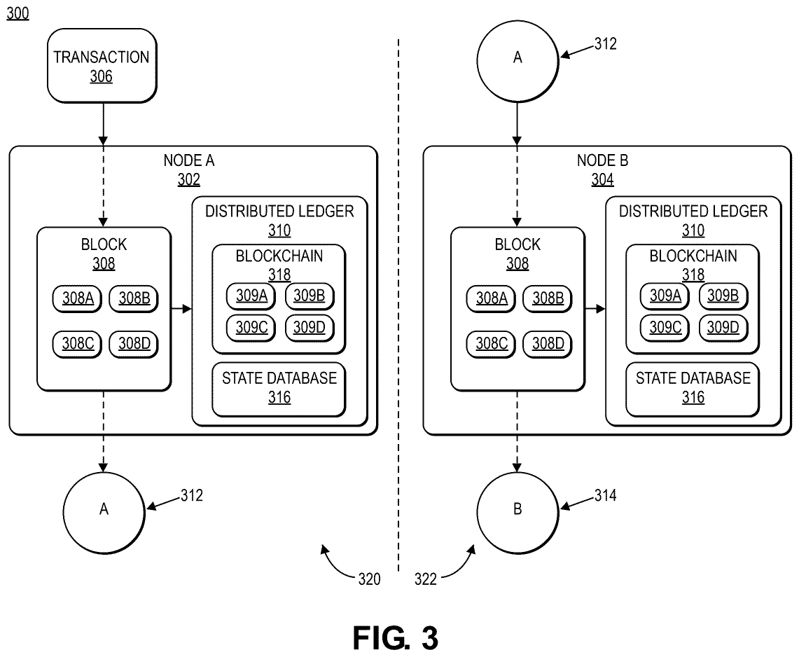

FIG. 3 depicts a block diagram of example network nodes (e.g., nodes 150, 160, 202, 204, 206, 208, 210) and an example transaction flow 300 on a distributed ledger network for managing income streams. FIG. 3 includes two time frames 320 and 322, represented by the left and right sides of the dotted line, respectively. FIG. 3 includes Node A 302 (e.g., node 150) and Node B 304 (e.g., node 160), each including a set of transactions 308A-308D, a set of blocks of transactions 309A-309D, a distributed ledger 310 (e.g., the distributed ledger 180, 212), a state database 316, and a blockchain 318. It will be understood that the example network nodes 302, 304 may include additional, fewer, and/or alternate components. It will also be understood that the example transaction flow 300 may include additional, fewer, and/or alternate steps.

The transaction flow 300 may begin with Node A 302 receiving a transaction 306 at the time frame 320, such as a transaction received from the income management platform 116 of FIG. 1 to mint a soulbound token corresponding to an income stream on the distributed ledger. In at least some aspects, mining the soulbound token may include encryption and/or privacy-preserving techniques reflected in the transaction 306. When Node A 302 confirms that transaction 306 is valid, Node A 302 may add the transaction 306 to a newly generated block 308. As part of adding the transaction 306 to block 308, Node A 302 may solve a cryptographic puzzle and include the solution in the newly generated block 308 as proof of the work done to generate the block 308. Alternatively, a proof of stake algorithm may be used to generate the block 308, whereby Node A 302 “stakes” an amount of a digital token used on the network, however, the network itself determines the node that will mint the new block. In other embodiments, a proof of authority (PoA) algorithm may be used to generate the block 308, where transactions and blocks are validated (e.g., via the validator module 156) by approved accounts, known as validators that record transactions in the distributed ledger.

In other embodiments, the transaction 306 may be added to a pool of transactions until a sufficient number of transactions in the pool exist to form a block or distributed ledger entry. Node A 302 may transmit the newly created distributed ledger entry 308 to the distributed ledger network at time 312. In the example where the transaction 306 is to mint the soulbound token, validating and recording the transaction 306 of the block 308 on the distributed ledger 310 mints the soulbound token on the distributed ledger 310. Before or after propagating the distributed ledger entry 308, Node A 302 may add the distributed ledger entry 308 to its copy of the blockchain 318.

While proof of work, proof of stake, and proof of authority are described herein as consensus algorithms for selecting a node to mint a new block, these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of weight, Byzantine fault tolerance, tangle consensus algorithms, block lattice consensus algorithms, etc. Additionally, quorum slices may be selected where a quorum is a set of nodes that participate in the consensus protocol and a quorum slice is its subset that helps a node in its agreement process. Individual trust decisions may be made by participants in the distributed ledger network to construct a quorum slice. Still further, security circles may be identified which are closed groups of network participants who together can form a quorum to reach a consensus on a transaction and to make further trust decisions.

In any event, the transactions 309A-309D may include updates to the state database 316. The state database 316 may contain current values of variables created by smart contracts deployed on the blockchain 318. In some aspects, one or more smart contracts deployed on the blockchain 318 may be associated with distributing income from an income stream represented by the soulbound token minted on the distributed ledger 310. The smart contracts may include variables which act as conditional triggers to perform the income distribution proscribed by the smart contract. For example, a transaction recorded on the distributed ledger 310 may indicate that the balance in a digital wallet from the income stream corresponding to the minted soulbound token is above a threshold amount, triggering a condition of the smart contract to automatically distribute to a portion of the income into a retirement account. Validated distributed ledger entries may include transactions that influence state variables in the state database 316.

At time frame 322, Node B 304 may receive the newly created distributed ledger entry 308 via the distributed ledger network at 312. Node B 304 may verify that the distributed ledger entry 308 is valid by checking the solution to the cryptographic puzzle provided in the distributed ledger entry 308. If the solution is accurate, then Node B 304 may add the distributed ledger entry 308 to its blockchain 318 and make any updates to the state database 316 as a result of the transaction(s) in distributed ledger entry 308. Node B 304 may then transmit the distributed ledger entry 308 to the rest of the network at time 314.

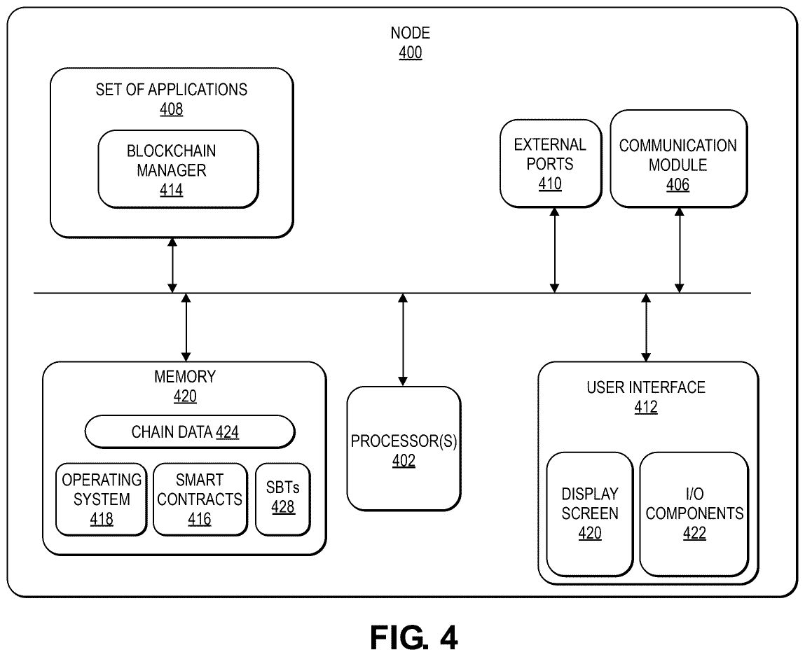

FIG. 4 depicts a block diagram of example components of an example network node 400 on a distributed ledger network for managing income streams (e.g., distributed ledger 180). The network node 400 may be similar to the network nodes 150, 160 described above with reference to FIG. 1. Network node 400 may include at least one processor 402, memory 404, a communication module 406 such as a transceiver, a set of applications 408, external ports 410, a blockchain manager 414, smart contracts 416, soulbound tokens 428, an operating system 418, user interface 412, display screen 420, and/or I/O components 422. It will be understood that the example network node 400 may include additional, fewer, and/or alternate components.

The blockchain manager 414 may be an application configured to perform various functions associated with the blockchain and/or distributed ledger, such as those just described with respect to the example transaction flow 300. In some embodiments, the network node 400 may generate a new block of transactions (e.g., the block 308), or may broadcast transactions to other network nodes via the communication module 406 by using the blockchain manager 414. Similarly, the network node 400 may use the blockchain manager 414 in conjunction with the soulbound tokens 428 and/or the smart contracts 416 stored in the memory 404 (e.g., as code to be deployed to the blockchain) to provide the functionality disclosed herein. The memory 404 may further include chain data 424 including, for example, a state database (e.g., state database 316) for storing states of smart contracts deployed thereon.

In other embodiments, the smart contracts 416 operate independent of the blockchain manager 414 or other applications. In some embodiments, the network node 400 does not have a blockchain manager 414, the soulbound tokens 428, and/or the smart contracts 416 stored at the network node 400.

### Example Machine Learning Training

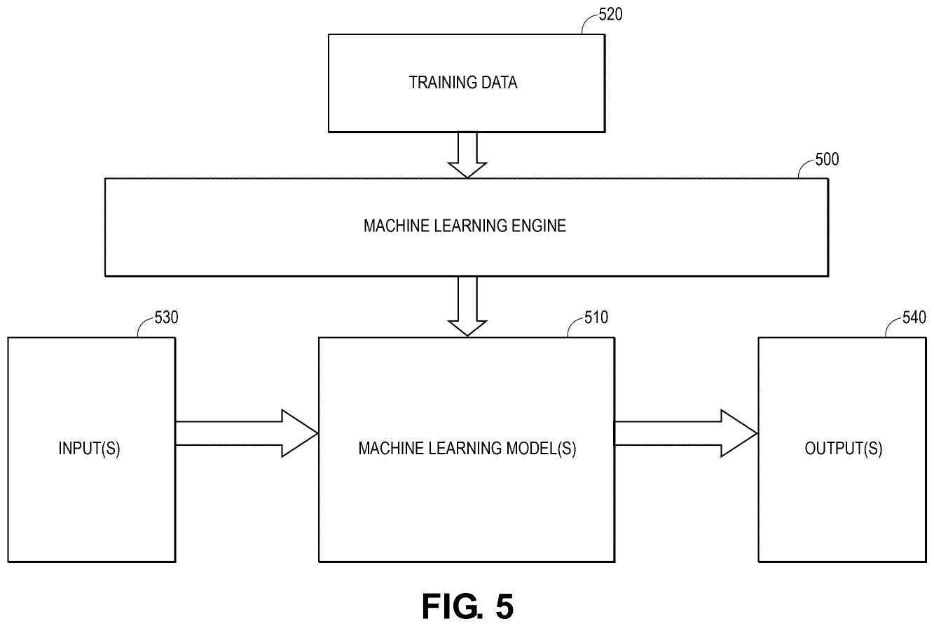

FIG. 5 illustrates a flow diagram for example training and operation of an example machine learning model, such as one or more of the machine learning models 118. A machine learning engine 500 may train a machine learning model 510 using training data 520. Once trained, the machine learning model 510 may receive one or more inputs 530 to generate one or more outputs 540.

In some embodiments, the machine learning engine 500 employs supervised learning, which involves identifying patterns in existing data to make predictions about subsequently received data. Specifically, the machine learning engine 500 initiates machine learning model 510 training using training data 520 which includes example inputs and associated example outputs. Based upon the training data 520, the machine learning engine 500 may generate a predictive function which maps outputs to inputs and may utilize the predictive function to generate machine learning outputs based upon data inputs. The example inputs and example outputs of the training data may include any of the data inputs or machine learning outputs disclosed herein. In example embodiments, a processing element is trained by providing it with a large sample of training data 520 with known characteristics or features.

In other embodiments, the machine learning engine 500 may employ unsupervised learning, which involves finding meaningful relationships in unorganized data. Unlike supervised learning, unsupervised learning does not involve training based upon example inputs with associated outputs. Rather, in unsupervised learning, the machine learning engine 500 may organize unlabeled data according to a relationship determined by at least one machine learning method/algorithm employed by the machine learning engine 500. Unorganized data may include any combination of data inputs and/or machine learning outputs as described above.

In yet other embodiments, the machine learning engine 500 may employ reinforcement learning, which involves optimizing outputs based upon feedback from a reward signal. Specifically, the machine learning engine 500 may receive a user-defined reward signal definition, receive a data input, utilize a decision-making model to generate the machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

The machine learning engine 500 may receive labeled data at an input layer of a model having a networked layer architecture (e.g., an artificial neural network, a convolutional neural network, etc.) for training the one or more machine learning models 510. The received data may be propagated through one or more connected deep layers of the machine learning model to establish weights of one or more nodes, or neurons, of the respective layers. Initially, the weights may be initialized to random values, and one or more suitable activation functions may be chosen for the training process. The present techniques may include training a respective output layer of the one or more machine learning models 510. The output layer may be trained to output a prediction.

In some embodiments, the machine learning engine 500 may include one or more hardware and/or software components to obtain, create, (re)train, fine-tune, and/or store one or more machine learning models, such as the machine learning model 510. To train the machine learning model 510, the machine learning engine 500 may obtain and/or have available (e.g., in the database 130) one or more types of training data 520. The training data may include historical financial data, such as historical income stream information, historical financial goals, historical distributions, historical soulbound token information, historical distribution criteria, historical distribution insights, historical income distribution schemes, historical financial domain information, and/or any other suitable training data. In some aspects, at least some of the training data 520 may be labeled to aid in (re)training and/or fine-tuning the machine learning model 510. During training of the machine learning model 510 by the machine learning engine 500, the machine learning model 510 may be configured to process the training data 520 to learn associations and relationships in the training data 520.

In some embodiments, the machine learning engine 500 may update the training data 520 as needed (e.g., to include new data). Subsequently, the machine learning model 510 may be retrained using the updated training data 520, or the new portions thereof, which may cause the machine learning model 510 to improve its performance over time.

In some embodiments, the machine learning engine 500 may train the machine learning model 510 using the training data 520 to generate the output 540 based upon receiving the input 530. Once trained, the machine learning model 510 may perform operations on one or more data inputs 530 to produce a desired data output 540, such as generating distribution insights based upon receiving distribution criteria and soulbound token information and/or generating distribution schemes based upon receiving the distribution insights.

In some aspects, the machine learning model 510 is loaded at runtime from a database (e.g., model 510 loaded by machine learning engine 500 from the database 130). A server, other computing device (e.g., the computing device 110), and/or machine learning engine 500 may obtain the input data 530, and the machine learning engine 500 may provide the input data 530 to the trained machine learning model 510 as an input, for the machine learning model 510 to generate the output 540.

In at least some aspects, the same server, computing device and/or other suitable component/device, both trains the machine learning model 510, and executes the trained machine learning model 510. In at least some aspects, a first server, computing device, and/or other suitable component/device trains the machine learning model 510, and a second server, computing device, and/or other suitable component/device executes the trained machine learning model 510.

### Example Generative AI

The machine learning model 510 may be a generative model and/or include generative functionality allowing the machine learning model 510 to generate new content, such as images, text, or other forms of data, that is similar to, or inspired by, existing examples. Generative models operate on principles derived from machine learning, as previously described.

In some embodiments, the machine learning model 510 may be or include a Generative Adversarial Network (GAN). In some embodiments, GANs consist of two neural networks—the generator and the discriminator—that are trained in tandem through adversarial training. The generator aims to create data that is indistinguishable from real examples, while the discriminator's role is to differentiate between genuine and generated data. As part of the adversarial training, the generator and the discriminator iteratively compete and improve, and the generator becomes adept at producing increasingly realistic content.

In further embodiments, the machine learning model 510 may include and/or be trained with Recurrent Neural Networks (RNNs) or transformers, which are used for sequential data generation, such as natural language text. These models learn patterns and dependencies in the training data and can then generate new sequences by predicting the next element based on the context provided.

In at least some aspects, the machine learning model 510 (e.g., a machine learning chatbot) may be trained to generate responses to requests using natural language. In at least some aspects, the machine learning model 510 may be trained to generate code for blockchain transactions, such as code associated with one creating smart contacts on the distributed ledger to manage an income stream corresponding to the soulbound token. For example, when trained with historical smart contract code to distribute income from an income stream, the machine learning model 510 may be able to generate similar code for creating new smart contracts to distribute income from an income stream recorded on the distributed ledger as the soulbound token. In at least some aspects, the machine learning model 510 is a chatbot trained to provide financial advice, distribution insights, distribution schemes, domain insights, etc., in a conversation manner using natural language. The chatbot may be configured to interact with the user when providing responses to user requests.

### Example LLM

The present techniques may include language modeling via one or more LLMs wherein one or more models (e.g., deep learning models) are trained by processing token sequences using an LLM architecture. For example, a transformer architecture may be used to process a sequence of tokens. The transformer model may include a plurality of layers including self-attention and feed-forward neural networks. The transformer architecture may enable the model to learn contextual relationships between the tokens, and to predict the next token in a sequence, based upon the preceding tokens. During training, the model is provided with the sequence of tokens and it learns to predict a probability distribution over the next token in the sequence. The training process may include updating one or more model parameters (e.g., weights or biases) using an objective function that minimizes the difference between the predicted distribution and a true next token in the training data.

Alternatives to the transformer architecture may include recurrent neural networks, long short-term memory networks, gated recurrent networks, convolutional neural networks, recursive neural networks, and other modeling architectures.

In some aspects, the machine learning engine 500 may include instructions for performing pretraining of a language model. The machine learning engine 500, for example, may include one or more sets of instructions for performing pretraining, which, as used herein, generally refers to a process that may span pre-processing of training data and initialization of an as-yet untrained language model. In general, a pre-trained model is one that has no prior training of specific tasks. For example, the model pretraining module may include instructions that initialize one more model weights. In some aspects, machine learning engine 500 may initialize the weights to have random values. The pretraining may train one or more models using unsupervised learning, wherein the one or more models process one or more tokens (e.g., preprocessed data) to learn to predict one or more elements (e.g., tokens). The pretraining may include one or more optimizing objective functions that the model pretraining module applies to the one or more models, to cause the one or more models to predict one or more most-likely next tokens, based on the likelihood of tokens in the training data. In general, the model pretraining causes the one or more models to learn linguistic features such as grammar and syntax. The pretraining may include additional steps, including training, data batching, hyperparameter tuning, and/or model checkpointing.

The model pretraining may include instructions for generating a language model that is pretrained for a general purpose, such as general text processing and/or language understanding. This model may be known as a “base model” in some aspects. The base model may be further trained by downstream training process(es), for example via the machine learning engine 500. Pretraining may be a distinct stage of model training in which training data of a general and diverse nature (i.e., not specific to any particular task or subset of knowledge) is used to train the one or more models. In some aspects, a single model may be trained and copied to provide a plurality of base which are subsequently fine-tuned to become a plurality of fine-tuned models. In this way, the base model can start from a relatively advanced stage, without requiring pretraining of each more advanced model individually.

In some aspects, base models may be trained to have specific levels of knowledge. For example, a base language model may be subsequently trained/fine-tuned with financial knowledge to become a fine-tuned financial language model having general financial knowledge. The fine-tuned financial language model having general financial knowledge may be copied to create a plurality of financial language models. The plurality of financial language models may then act as base models which are fine-tuned using a plurality of training datasets associated with a plurality of financial domains to generate a plurality of fine-tuned machine learning language models have knowledge of a specific financial domains, for example to generate one or more financial domain insights.

### Example Training of an Example Chatbot

A company may use a chatbot to, inter alia, provide income steam management services (e.g., recommendations for income distributions) in a conversational-like manner, as previously described. The chatbot may be capable of understanding requests and providing relevant information responsive to the requests. Additionally, the chatbot may generate data from interactions which may be used to retrain the chatbot and improve its functionality. Moreover, although the following discussion may refer to a machine learning chatbot or a machine learning model, it should be understood that it applies equally to an artificial intelligence (AI) chatbot or an AI model, as terms such as artificial intelligence and machine learning may be used interchangeably herein.

The chatbot may be trained by any suitable component (e.g., the machine learning module 120, the machine learning engine 500, etc.) using large training datasets of text, which may provide sophisticated capability for natural-language tasks, such as answering questions and/or holding conversations. The chatbot may include a general-purpose pretrained LLM as described above which, when provided with a starting set of words (e.g., a prompt) as an input, may attempt to provide an output (e.g., a response) of the most likely set of words that follow from the input. In some examples, the input prompt includes a request to manage an income stream, such requesting a distribution scheme to distribute income according to distribution criteria.

In at least some aspects, the prompt may be provided to, and/or the response received from, the chatbot and/or any other machine learning model via a user interface. For example, the computing device 110 may provide a user interface to manage income streams, such as a graphical user interface of the income management platform 116, the user computing device 140 may provide a user interface to manage income streams, such as a graphical user interface of the income management client application 146, etc. The user interface may be configured to receive input from, and provide output to, one or more user interface devices, such as a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances, which may require the chatbot to keep track of an entire conversation history as well as the current state of the conversation. The chatbot may rely on various techniques to engage in conversations with users, which may include the use of short-term and long-term memory. Short-term memory may temporarily store information (e.g., in the memory 114) that may be required for immediate use and may keep track of the current state of the conversation and/or to understand the user's latest input in order to generate an appropriate response. Long-term memory may include persistent storage of information (e.g., in the memory 114, the database 130, etc.) which may be accessed over an extended period of time. The chatbot may use the long-term memory to store information from the chat session (e.g., income stream information or distribution criteria the user provides, the chat history, etc.) and may be useful for improving an overall user experience by enabling the chatbot to personalize and/or provide more informed responses.

In some embodiments, the system and methods to generate and/or train a machine learning model which may include and/or be used as the chatbot, may include multiple steps.

The first step may be a supervised fine-tuning (SFT) step where a pretrained language model (e.g., an LLM) may be fine-tuned on a relatively small amount of demonstration data curated by human labelers to learn a supervised policy (SFT machine learning model) which may generate responses/outputs from a selected list of prompts/inputs. The SFT machine learning model may represent a cursory model for what may be later developed and/or configured as the machine learning chatbot model. The second step may be a reward model step where human labelers may rank numerous SFT machine learning model responses to evaluate the responses which best mimic preferred human responses, thereby generating comparison data. The reward model may be trained on the comparison data. The third step may be a policy optimization step in which the reward model may further fine-tune and improve the SFT machine learning model. The outcome of this step may be the machine learning chatbot model using an optimized policy. In some aspects, step one may take place only once, while steps two and three may be iterated continuously, e.g., more comparison data is collected on the current machine learning chatbot model, which may be used to optimize/update the reward model and/or further optimize/update the policy.

### Supervised Fine-Tuning

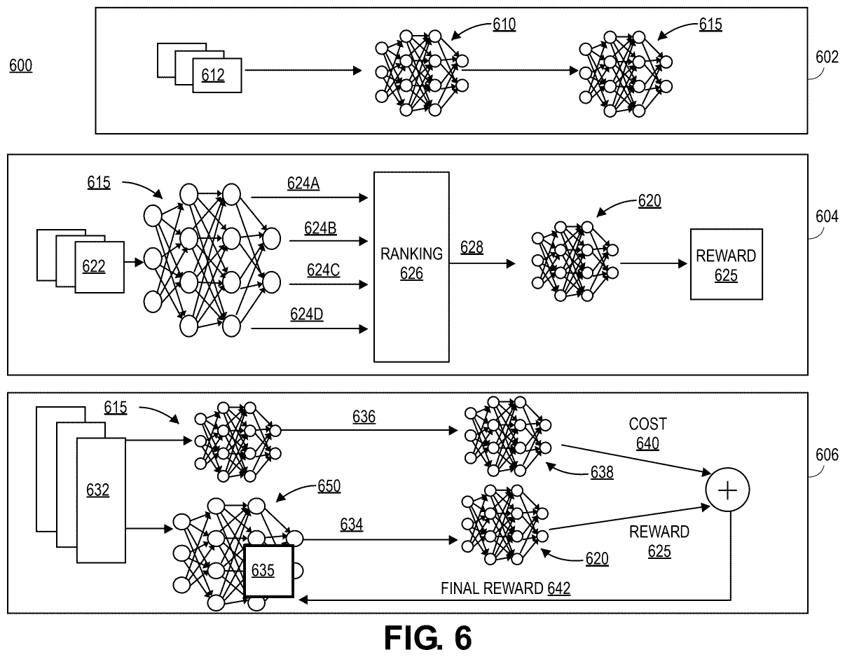

As an initial matter, although the discussion with respect to FIG. 6 refers to machine learning chatbot model 650, it should be understood that 650 may refer equally to an AI and/or machine learning algorithm and/or model.

FIG. 6 depicts a combined block and logic diagram 600 for example training of an example machine learning chatbot, in which the techniques described herein may be implemented, according to some embodiments. It should be understood that the techniques described with regard to FIG. 6 may apply to training for any chatbot as described herein. In addition, the chatbot may be trained in accordance with any of the other techniques described herein, and the training of chatbot should not be considered restricted to the teachings of FIG. 6.

Some of the blocks in FIG. 6 may represent hardware and/or software components; other blocks may represent data structures or memory storing these data structures, registers, or state variables (e.g., 612); and still other blocks may represent output data (e.g., 625). Input and/or output signals may be represented by arrows labeled with corresponding signal names and/or other identifiers. The methods and systems may include one or more blocks 602, 604, 606, which will be described in further detail below.

In some aspects, at block 602, a pretrained language model 610 may be fine-tuned, for example fine-tuned with financial knowledge (general financial knowledge, domain-specific knowledge) to provide income stream management. The pretrained language model 610 may be obtained at block 602 and be stored in a memory, such as memory 114. The pretrained language model 610 may be loaded into a machine learning training module (e.g., machine learning module 120, machine learning engine 500) at block 602 for retraining/fine-tuning. A supervised training dataset 612 may be used to fine-tune the pretrained language model 610 wherein each data input prompt to the pretrained language model 610 may have a known output response for the pretrained language model 610 to learn from. The supervised training dataset 612 may be stored in a memory at block 602 (e.g., the memory 114) In some aspects, the data labelers may create the supervised training dataset 612 prompts and appropriate responses. The pretrained language model 610 may be fine-tuned using the supervised training dataset 612 resulting in the SFT machine learning model 615. The SFT machine learning 615 may provide appropriate responses to user prompts once trained. The trained SFT machine learning model 615 may be stored in a memory, such as the memory 114.

In some aspects, the supervised training dataset 612 may include prompts and responses (e.g., questions and answers, etc.) which may be relevant to user. An example of prompts and responses include prompts requesting how much income should be saved to reach a specific financial goal before retirement, and the corresponding responses indicates the amount of income to reach the financial goal. For instance, a user may ask “How much do I need to save every month to have half a million dollars in retirement by the time I retire in 30 years?” Example responses from the trained SFT machine learning model 615 may include “Saving at least $1,1100 per month is suggested to have an estimated retirement savings of one million dollars within 30 years.” The responses may include answers to the user's question/request, additional questions associated with the request, or a generative output such as a smart contract code (e.g., a smart contract to automatically transfer $1,100/month from an income stream into retirement savings). In some embodiments, the supervised training dataset 612 may include historical financial information (e.g., historical information of income streams, distribution criteria, distribution insights, distribution schemes), historical data from historical conversations, historical questions and answers, etc.

### Training the Reward Model

In some aspects, training the machine learning chatbot model 650 may include, at block 604, training a reward model 620 to provide, as an output, a scaler value/reward 625. The reward model 620 may leverage reinforcement learning from human feedback (RLHF) in which a model (e.g., machine learning chatbot model 650) learns to produce outputs which maximize its reward 625, and in doing so may provide responses which are better aligned to user prompts.

Training the reward model 620 may include, at block 604, providing a single prompt 622 to the SFT machine learning model 615 as an input. The input prompt 622 may be provided via an input device (e.g., a keyboard) of the computing device 110. The prompt 622 may be previously unknown to the SFT machine learning model 615, for example the labelers may generate new prompt data, the prompt 622 may include testing data stored on memory 114, and/or any other suitable prompt data. The SFT machine learning model 615 may generate multiple, different output responses 324A, 324B, 324C, 324D to the single prompt 622. At block 604, the computing device 110 may output the responses 324A, 324B, 324C, 324D via any suitable technique, such as outputting via a display (e.g., as text responses), a speaker (e.g., as audio/voice responses), etc., for review by the data labelers.

The data labelers may provide feedback (e.g., via the computing device 110, etc.) on the responses 324A, 324B, 324C, 324D when ranking 626 them from best to worst based upon the prompt-response pairs. The data labelers may rank 626 the responses 624A, 624B, 624C, 624D by labeling the associated data. The ranked prompt-response pairs 628 may be used to train the reward model 620. In some aspects, the computing device 110 may load the reward model 620 and train the reward model 620 using the ranked response pairs 628 as input. The reward model 620 may provide as an output the scalar reward 625.

In some aspects, the scalar reward 625 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 620 may generate a winning reward. Inputting a “losing” prompt-response pair data to the same reward model 620 may generate a losing reward. The reward model 620 and/or scalar reward 625 may be updated based upon labelers ranking 626 additional prompt-response pairs generated in response to additional prompts 622.

In some examples, a data labeler may provide to the SFT machine learning model 615 as an input prompt 622, “Describe the sky.” The input may be provided by the labeler (e.g., via the computing device 110, etc.) to the computing device 110 providing the chatbot that utilizes the SFT machine learning model 615. The SFT machine learning model 615 may provide as output responses to the labeler (e.g., via their respective devices): (i) “the sky is above” 624A; (ii) “the sky includes the atmosphere and may be considered a place between the ground and outer space” 624B; and (iii) “the sky is heavenly” 624C. The data labeler may rank 626, via labeling the prompt-response pairs, prompt-response pair 622/624B as the most preferred answer; prompt-response pair 622/624A as a less preferred answer; and prompt-response 622/624C as the least preferred answer. The labeler may rank 626 the prompt-response pair data in any suitable manner. The ranked prompt-response pairs 628 may be provided to the reward model 620 to generate the scalar reward 625. It should be appreciated that this facilitates training the chatbot to compose explanations of why authentication attempts were approved or rejected; and/or requests for additional information.

While the reward model 620 may provide the scalar reward 625 as an output, the reward model 620 may not generate a response (e.g., text). Rather, the scalar reward 625 may be used by a version of the SFT machine learning model 615 to generate more accurate responses to prompts, i.e., the SFT model 615 may generate the response such as text to the prompt, and the reward model 620 may receive the response to generate a scalar reward 625 of how well humans perceive it. Reinforcement learning may optimize the SFT model 615 with respect to the reward model 620 which may realize the configured machine learning chatbot model 650.

### RLHF to Train the Machine Learning Chatbot Model

In some aspects, the computing device 110 may train the machine learning chatbot model 650 to generate a response 634 to a random, new and/or previously unknown user prompt 632. To generate the response 634, the machine learning chatbot model 650 may use a policy 635 (e.g., algorithm) which it learns during training of the reward model 620, and in doing so the model may advance from the SFT model 615 to the machine learning chatbot model 650. The policy 635 may represent a strategy that the machine learning chatbot model 650 learns to maximize its reward 625. As discussed herein, based upon prompt-response pairs, a human labeler may continuously provide feedback to assist in determining how well the machine learning chatbot's 650 responses match expected responses to determine rewards 625. The rewards 625 may feed back into the machine learning chatbot model 650 to evolve the policy 635. Thus, the policy 635 may adjust the parameters of the machine learning chatbot model 650 based upon the rewards 625 it receives for generating good responses. The policy 635 may update as the machine learning chatbot model 650 provides responses 634 to additional prompts 632.

In some aspects, the response 634 of the machine learning chatbot model 650 using the policy 635 based upon the reward 625 may be compared using a penalty function 638 to the SFT machine learning model 615 (which may not use a policy) response 636 of the same prompt 632. At block 606 a penalty 640 may be computed based upon the penalty function 638 of the responses 634, 636. The penalty 640 may reduce the distance between the responses 634, 636, i.e., a statistical distance measuring how one probability distribution is different from a second, in some aspects the response 634 of the machine learning chatbot model 650 versus the response 636 of the SFT model 615. Using the penalty 640 to reduce the distance between the responses 634, 636 may avoid a server over-optimizing the reward model 620 and deviating too drastically from the human-intended/preferred response. Without the penalty 640, the machine learning chatbot model 650 optimizations may result in generating responses 634 which are unreasonable but may still result in the reward model 620 outputting a high reward 625.

In some aspects, the responses 634 of the machine learning chatbot model 650 using the current policy 635 may be passed to the reward model 620, which may return the scalar reward 625. The machine learning chatbot model 650 response 634 may be compared via the penalty function 638 to the SFT machine learning model 615 response 636 to compute the penalty 640. A final reward 642 may be generated which may include the scalar reward 625 offset and/or restricted by the penalty 640. The final reward 642 may be provided to the machine learning chatbot model 650 and may update the policy 635, which in turn may improve the functionality of the machine learning chatbot model 650.

To optimize the machine learning chatbot model 650 over time, RLHF via the human labeler feedback may continue ranking 626 responses of the machine learning chatbot model 650 versus outputs of earlier/other versions of the SFT machine learning model 615, i.e., providing positive or negative rewards 625. The RLHF may allow the training process to continue iteratively updating the reward model 620 and/or the policy 635. As a result, the machine learning chatbot model 650 may be retrained and/or fine-tuned based upon the human feedback via the RLHF process, and throughout continuing conversations may become increasingly efficient.

Although multiple blocks 602, 604, 606 are depicted in the example block and logic diagram 600, each providing one of the three steps of the overall machine learning chatbot model 650 training, fewer and/or additional blocks may be utilized and/or may provide the one or more steps of the chatbot training. In some variations, each block 602, 604, 606 represents one or more servers (e.g., each server performs a different training stage, etc.).

### Example Income Stream Management

An income management platform (“management platform”) integrated with one or more distributed ledgers, such as the income management platform 116, may provide management of income streams. The management platform and/or a management platform client application (e.g., the income management client application 146) may generate a user interface, accessible by the computing device (e.g., the computing device 110, the user computing device 140), to manage income streams.

The management platform may receive or otherwise obtain (e.g., from the database 130) distribution criteria associated with distributing at least a portion of income received from the income stream to one or more distribution recipients. The distribution criteria may include a rule or condition (distribution condition) to distribute the income, a distribution recipient to receive the income, an amount of the income to distribute (distribution amount), a schedule or other temporal indication of when the distribute the income (distribution timing), or any other criteria associated with distributing income. The management platform may receive and/or obtain the distribution criteria via a computing device, such as the computing device 110 the user computing device 140, and/or any other suitable source.

In at least some embodiments, the management platform is integrated with a variety of data which does not reside on the blockchain or distributed ledger, referred to as “external data.” The management platform may bridge the external data onto the blockchain/distributed ledger for example via machine models, an oracle (e.g., a third-party service, a first party oracle, etc.), or other suitable means. The data sources may be associated with income distribution, for example external data used to trigger a condition of a smart contract (automatically) managing income flows, for example increasing an income distribution amount based upon external data indicating high inflation. Some examples of external data may include economic data, such as consumer price indices for tracking inflation/cost-of-living, pricing data (e.g., labor, housing, and goods/services pricing), bank interest rates, monetary policy changes, macro trends in domestic and international financial markets, and/or other suitable economic data. The external data may include healthcare data and/or environmental data, which may include sensor data (e.g., internet-of-things sensors, smart home sensors, environmental sensors), weather, pollution, wearable health monitoring device data (e.g., Apple Watch, Fit Bit), and/or any other suitable external data that may be used to manage income streams.

The management platform may implement one or more “AI agents” (e.g., machine learning models, machine learning chatbots) to optimize the distribution of income. In at least some aspects, the AI agents may independently manage income distribution without user intervention, for example creating and deploying an income distribution scheme based upon the distribution criteria, external data, insights into the income stream and how it is managed, etc.

For example, the AI agent may autonomously rebalance (e.g., via one or more smart contracts) the allocation income from one or more income streams based upon the recent financial performance of the management platform user's retirement accounts.

In at least some aspects, the AI agents may be configured to execute instructions or requests from the management platform user (e.g., a retiree), ingest and generate data (e.g., receive distribution criteria and soulbound token information to generate distribution insights), provide financial analytics (e.g., income stream performance, income stream sources, income distributions, digital wallet balance), forecast income, model financial goals, optimize income deployment strategies, and the like.

The management platform (e.g., via the AI agent) may be configured to obtain soulbound token information associated with the soulbound token corresponding to the income stream. The management platform may obtain the soulbound token information from the distributed ledger, the blockchain, the user, a database, the income stream source, and/or any other suitable source of soulbound token information. The soulbound token information may include characteristics of the soulbound token (e.g., the soulbound token owner, the address of the digital wallet in which the soulbound token is located), characteristics of the corresponding income stream (e.g., the income source, the income amount, the income frequency), characteristics of smart contracts associated with the soulbound token (e.g., their function, conditions, income amounts they are configured to distribute), and/or any other suitable characteristic of the soulbound token.

The AI agent may analyze the distribution criteria and/or the soulbound token information to generate one or more income distribution insights (distribution insights) associated with optimizing the income distribution. For example, the distribution insights may include income analytics, income forecasting, financial goal modeling, financial advice, income distribution recommendations, and/or any other suitable. The management platform may display or otherwise provide the distribution insights (e.g., via a user interface, client application, electronic message, etc.). In at least some aspects, the management platform and/or AI agent may receive feedback associated with the one or more distribution insights, such as feedback from the owner of the income stream via the management platform or other computing device.

The AI agent may generate one or more income distribution schemes associated with distributing at least the portion of the income to the one or more distribution recipients. The AI agent may generate the income distribution schemes based upon the one or more distribution insights described above. In at least some aspects, the one or more distribution schemes may include automatically depositing and/or distributing income from the income stream to one or more income recipients such as a digital wallet, a bank account or other financial account, and/or any other suitable recipient. The one or more one or more distribution schemes may include automatically distributing the income from the income recipient to one or more distribution recipients, such as distributing income from the management platform user's bank account as a physical check provided to a mortgage provider to pay a mortgage bill.

The AI agent may implement the distribution scheme via one or more smart contracts associated with the income stream corresponding to the soulbound token. In at least some aspects, the AI agent may include generative capabilities including generating the smart contract code, and the blockchain transaction associated with the smart contract. The management platform (e.g., via the AI agent) may provide the blockchain transaction to a node of the distributed ledger for validation and recordation on the blockchain. In at least some aspects, the AI agent may implement distribution schemes without user intervention (e.g., dynamically creating smart contracts for an income stream based upon fluctuating market conditions, and deploying the smart contract to the distributed ledger), or with user intervention (e.g., upon user review and approval of distribution schemes).

In at least some embodiments, the AI agent is, or includes, a machine learning chatbot. The machine learning chatbot may receive one or more requests to manage the income stream from a user of a computing device (e.g., via a user interface generated by the income management client application 146 on the user computing device 140). The machine learning chatbot may generate one or more responses to the one or more requests, and provide the responses to the computing device.

In some embodiments, one or more machine learning models provided by the management platform, such as the AI agent, may be fine-tuned. In at least some aspects, the machine learning model may be fine-tuned (also referred to as training or retraining) using a plurality of training datasets associated with a plurality of financial domains. The fine-tuning may result in a plurality of fine-tuned machine learning models that are trained to generate financial domain-specific information and insights, such as distribution insights specific to a financial domain. The plurality of fine-tuned machine learning models may be stored in a memory, such as the memory 114, the database 130, etc.

In at least some aspects, the management platform may use one or more fine-tuned machine learning models as the machine learning model (e.g., the AI agent) to generate the distribution insights that include financial domain-specific insights. The management platform may identify one or more fine-tuned machine learning models to use as the machine learning model, or the user may select the fine-tuned machine learning model (e.g., via the management platform user interface). The management platform may identify a particular fine-tuned machine learning model based upon information in the distribution criteria, the soulbound token information, the distribution insights, the distribution scheme, the chatbot request (e.g., the best-suitable fine-tuned machine learning model to respond to the request), and/or in any other suitable manner.

In at least some aspects, the one or more machine learning models (e.g., the AI agents) may collaborate with one another to manage one or more income streams. In at least some aspects, the AI agents may have different knowledge or capabilities, for example, an AI agent to ingestion external data, an AI agent for analytics, forecasting and goal modeling, an AI agent for income deployment strategy optimization, and an AI agent for monitoring feedback. In some examples, a first fine-tuned AI agent may manage a first income stream, and a second fine-tuned AI agent may manage a second income stream. In another example, multiple AI agents may collectively manage the same income stream.

In some embodiments, the management platform may be used to distribute income using payment streaming, such as real-time, continuous payment streaming (e.g., using a third party service and/or a first party service). The payment streaming may advantageously provide granular (e.g., per-second) income distribution, real-time access to income, smoothed income variability, integration with third party tools (e.g., accounting software), timely payment to third parties, among other operations.

### Example Income Stream Onboarding and Income Distribution

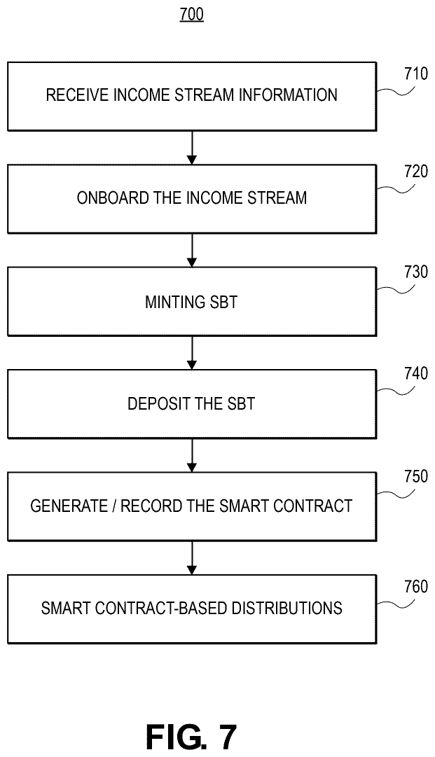

FIG. 7 depicts a flow diagram of an example workflow 700 for income stream onboarding and income distribution. The example workflow 700 may be implemented, for example, using the computing environment 100. In the example of FIG. 7, a computing device, such as the computing device 110, provides an income stream management platform (“management platform”) integrated with one or more distributed ledgers to manage income streams, such as the income management platform 116. Although the workflow 700 is generally described with respect to one distributed ledger, this is for illustration purposes, and one or more of the steps, processes, functions and/or the like associated with the described distributed ledger, may be performed on more than one distributed ledger.

The management platform may provide and/or perform onboarding of income streams, generating soulbound tokens and/or smart contracts (e.g., generating the associated blockchain transaction code), recording the soulbound tokens and/or the smart contract on the distributed ledger (e.g., by submitting associated transactions to the distributed ledger for validation and recording), and/or other such operations as described herein. In some embodiments, the user (e.g., the user), who in examples may be the recipient of income from the income streams or a third party to manage the income streams for the recipient (e.g., a retirement service provider), may manage the income streams via the management platform. For example, the user may use the user computing device (e.g., the user computing device 140) executing a client application (e.g., the income management client application 146) to access the management platform(e.g., the income management platform 116) via the network (e.g., network 170).

The example workflow 700 may begin with the management platform receiving income stream information associated with one or more income streams (block 710). Depending on the embodiment, the user computing device may provide and/or generate at least a part of the income stream information. For example, the user may provide the income stream information via the income stream management client application, and the user computing device may transmit the income stream information to the management platform via a network, such as the network 170. The management platform may obtain at least a portion of the income stream information from other sources, and/or in any suitable manner. In some examples, the income recipient may provide their user credentials for an online user account associated with the income stream, and the management platform may use the credentials to access the online account (e.g., via an application programming interface) and obtain the income stream information. In another example, a trusted third party (e.g., the income stream source) may provide at least a portion of the income stream information. In another example, the management platform may request the income stream information from one or more sources (e.g., via an electronic request provided to the one or more sources).

The income stream information may include any information associated with one or more income streams of the income recipient. In some examples, the income stream information may include an indication of the source of the income streams, such as pensions, social security accounts, individual retirement accounts (e.g., Roth, 401k, etc.), investments (e.g., dividends, interest, etc.), annuities, real estate (e.g., rental property income), and/or any other suitable income stream source information. In further embodiments, the income stream information may further include information associated with retirement income for a user. The income stream information may include, for the income stream, the income amount, income distribution frequency, income stream user account information (e.g., account number, type of account, online account user credentials, etc.), and/or any other suitable income stream information.

The example workflow 700 may include onboarding the income streams using the income stream information (block 720). Onboarding the income streams (block 720) may include adding the income streams to the management platform. In at least some embodiments, adding the income streams to the management platform may include creating a user account for the income stream recipient to manage the income streams; associating the income streams with the user, creating user credentials (e.g., a user name and password) to access the income streams on the management platform, and/or any other suitable process or action associated with onboarding the income streams (block 720).

In some aspects, onboarding the income streams (block 720) may include verifying the income stream, for example by confirming details of the income stream information. In at least come embodiments, the income stream information may be verified via the income stream source(s), income recipient financial statements (e.g., past income distributions into a user bank account), using a trusted third party, using artificial intelligence/machine learning (e.g., via a machine learning chatbot interacting with the income recipient to gather information for verification purposes), and/or in any other suitable manner. In some aspects, onboarding the income streams (block 720) may include verifying the identity of the recipient (e.g., via a thrusted third party, using decentralized identifier authentication of the income stream recipient such as ERC-1056 and/or an AI or ML model, using zero-knowledge proofs, etc.).

In some embodiments, the income recipient may use the management platform to onboard one or more income streams (block 720) and/or perform other actions associated with income stream management, advantageously providing the recipient the control to manage various income streams using a single platform. For example, the user may use the management platform client application executing on their user computing device to provide the income stream information, verify the income stream(s), verify a user identity, create a user account with the company (e.g., a retirement services provide) to associate with the onboarded income streams, etc.

The workflow 700 may include minting one or more soulbound tokens on the distributed ledger (block 730), wherein each soulbound token may correspond to each onboarded income stream. As previously described, the soulbound token is a digital token residing on a distributed ledger, and is defined by Ethereum's ERC-5484 standard. The soulbound token is configured to be non-transferable, may include information identifying the recipient (e.g., distinctive facets of an individual's identity such as financial milestones, educational accomplishments, etc.). During the minting process, relevant income stream metadata, such as the income amount, income frequency, and/or other income stream details, may be mapped onto the soulbound token. In some embodiments, the management platform may generate one or more blockchain transactions to mint each soulbound token, and provide the one or more transactions to a node (e.g., node 150, 160, 400) to verify and record the transactions on the distributed ledger, thereby minting the one or more soulbound tokens (block 730). In at least some aspects, the management platform may act as the node.

The transaction(s) to mint the soulbound token (block 730) may include information such as the soulbound token title, the soulbound token description (e.g., what income stream the soulbound token represents), the soulbound token characteristics (e.g., is soulbound/non-transferrable in nature), the user associated with the soulbound token (e.g., a user decentralized identifier, a user digital wallet address/identifier), the characteristics of the income stream (income frequency, amount, etc.), conditions for destroying (e.g., “burning”) the soulbound token, image(s)/media associated with the soulbound token, and/or any other such suitable data to mint the soulbound token.

In some embodiments, one or more smart contracts on the distributed ledger may be configured to mint the soulbound tokens (block 730). For example, the management platform may generate a smart contact including the aforementioned information associated with the soulbound token (e.g., the soulbound token title, the soulbound token characteristics, etc.), as well as data, code, or other instructions to mint the soulbound token on the distributed ledger. The management platform may provide the one or more transactions to mint the soulbound token(s) to a node for validation and recording on the distributed ledger. In some embodiments, the one or more soulbound tokens may be minted on the distributed ledger in a manner that does not involve the management platform (e.g., minted on the ledger using a third-party application, minted by a trusted party, and/or in any other suitable manner). By recording the customer's soulbound tokens on the distributed ledger, the soulbound tokens serve as a tamper-proof, immutable record of the customer's income streams.

The workflow 700 may include depositing each soulbound token into a digital wallet (e.g., a crypto wallet) associated with the income stream recipient (block 740). Obtaining identifying information of the income recipient's digital wallet(s) (e.g., the digital wallet address) may occur during onboarding (block 720), and/or in any other suitable manner. In at least some aspects, if the user does not have an existing digital wallet, or requires additional digital wallet(s), to receive the soulbound tokens, one or more digital wallets may be created (e.g., via the management platform). If multiple soulbound tokens for multiple income streams are minted, each soulbound token may be deposited into a different digital wallet associated with the income stream recipient, a subset of the soulbound tokens may be deposited into the same digital wallet while other subsets are deposited into other digital wallets, all the soulbound tokens may be deposited into the same digital wallet associated with the income stream recipient, or any combination thereof. As the soulbound tokens are created to be soulbound in nature, once the soulbound token is deposited in the digital wallet, it may not be transferred to another party/digital wallet, and serves as a tamper-proof, immutable record of ownership of the income stream by the income stream recipient.

A deposit of the soulbound token into the digital wallet (block 740) on the distributed ledger may occur in a manner similar to that described with respect to minting the soulbound token (block 730). For example, in some embodiments a computing device (e.g., a node maintaining the distributed ledger, the management platform, the user device, etc.) may deposit the soulbound token by providing one or more transactions (e.g., by the management platform, by a third party) to the distributed ledger to perform the deposit of the soulbound token into the digital wallet. As described with respect to minting the soulbound tokens (block 730), the one or more transactions may include one or more smart contracts to perform and/or facilitate depositing of the one or more soulbound tokens into the one or more digital wallets.

Although minting the soulbound token (block 730) and depositing the minted soulbound token into the digital wallet (block 740) are described as separate steps of the workflow 700, this is for ease of illustration only. For example, a transaction provided to the distributed ledger may include a smart contract which performs both minting the soulbound token (block 730) and depositing the soulbound token into the digital wallet (block 740), rather than having each step done as separate transactions. In some examples, one or more transactions may cause the soulbound token to be minted in the digital wallet, such that a separate step to deposit the soulbound token into the digital wallet (block 740) is not necessary.

The workflow 700 may include generating one or more smart contracts associated with the soulbound token(s), and/or recording the one or more smart contracts on the distributed ledger (block 750). The smart contracts may be configured to automatically perform an action, for example the distribution of income, associated with the income stream corresponding to the soulbound token associated with the smart contract. The management platform may generate, and/or provide the one or more smart contracts to a node of the distributed ledger for validation and recordation. As previously described with respect to other distributed ledger transactions (e.g., minting and depositing the soulbound token), the management platform may perform only a portion of the workflow 700 step of generating and/or recording one or more smart contracts on the distributed ledger (block 750). For example, the management platform may generate the smart contract code, and a third-party application may be used to submit a transaction with the code to the distributed ledger for validating and recording the smart contract.

The smart contract may be configured to automatically perform one or more actions, such as distributing income, based upon the occurrence of one or more trigger conditions indicated in the smart contract. In some aspects, the trigger condition may be a time-based trigger (e.g., a date to distribute income), an event-based trigger (e.g., an account balance exceeding a threshold, a stock market condition), or manual trigger (e.g., a trigger generated by the management platform). As previously described, the node of the distributed ledger may include a state database, such as state database 316, containing values of variables associated with conditions which may trigger the performance of the smart contract.

Data associated with a triggering condition of the smart contract may be provided to the smart contract in one or more ways. In some aspects, the data includes results of a blockchain transaction and is available to the smart contract on the distributed ledger. In some aspects, the income stream source may be integrated directly with the distributed ledger to record real-world income stream transactions as distributed ledger transactions available to the smart contract. In some aspects, an oracle or a device integrated with the distributed ledger may provide external, real-world data to the distributed ledger and/or the smart contract. The external, real-world data may include data from wearable devices, internet-of-things devices, data of financial markets, weather data, and/or any other suitable type of data that may be used by the smart contract to perform an action.

In some aspects, the income recipient may provide input associated with income distribution that is proscribed by the smart contract. For example, the income recipient may use the management platform (e.g., via the management platform client application) to indicate dates and income amounts for income distribution of an income source of a soulbound token, and the management platform may generate a smart contract to automatically perform the requested income distribution. The management platform may provide a transaction including the smart contract to a node of the distributed ledger, and upon validation and recordation of the transaction on the distributed ledger, the smart contract is able to automatically perform the distribution.

In some aspects, the management platform may provide algorithms, models, artificial intelligence, machine learning, and the like to provide financial insights (e.g., used to create the smart contract), to generate the smart contract, and/or to optimize an existing smart contract. The financial insights may be upon the income stream information, historical income distributions, financial goals and/or history of the income recipient, financial strategies, external data (e.g., financial market conditions), and/or any other suitable information. The AI may provide predictive analytics to adjust income stream distributions associated with smart contract(s). For example, the AI may generate a smart contract to automatically distribute half of the monthly income of an income stream to a recipient on a weekly basis based upon their present spending habits. In two months, the recipient may have paid off their mortgage, decreasing the monthly expenditures. As a result, the AI may revise the smart contract once the mortgage is paid off to distribute the income on a bi-weekly basis, reducing the amount of income distribution to the recipient by half. In some aspects, the AI may generate the smart contract automatically based upon the financial insights, and in other aspects the AI may seek approval from the income recipient to before generating a proposed smart contract.

The workflow 700 may include smart contract-based income distribution of income from an income stream (block 760). The smart contract-based income distribution (block 760) may include the income source providing the income to the recipient (e.g., via a transfer of the income into the recipient's digital wallet, via an electronic funds transfer into a financial account, via a money order, check, or other physical financial instrument provided to the income recipient), or some other action which results in the distribution of income to the recipient, such as submitting an income withdrawal request to the income source to perform the income distribution, providing the income as non-cryptocurrency funds from the income source to a third party which converts the income to cryptocurrency and deposits the cryptocurrency income into the receipt's digital wallet, and/or any other suitable means of income distribution. In some aspects, distributing the income may include redistributing income already received by the income recipient to one or more income redistribution recipients.

In some embodiments, the income distribution may be automatically performed by the associated smart contract (e.g., based upon the occurrence of a trigger condition). For example, the smart contract for a soulbound token may be configured to deposit income from the corresponding income stream as cryptocurrency into the digital wallet of the income recipient that owns the income stream. Any suitable income supported by the digital wallet may be deposited into the digital wallet, for example cryptocurrency, electronic funds from a financial institutions, etc.

In some embodiments, the management platform may perform, or cause to be performed, the income distribution proscribed by the smart contracts. For example, the user's digital wallet may be a crypto wallet which can only hold income in the form of cryptocurrency. The user indicates a preference to manage the income stream of the soulbound token deposited into their crypto wallet, but does not indicate a preference to receive the income as cryptocurrency (or indicates a preference to receive the income in another format, such as a generated check, direct deposit, cash, etc.). In such an example, the management platform may cause the income source to distribute the income into a bank account of the user according to the terms of the associated smart contract, and the income in the bank may be represented as being in the crypto wallet, allowing the user to manage the income stream using the management platform.

In some embodiments, the management platform may be used to distribute income using payment streaming, such as real-time, continuous payment streaming. The payment streaming may advantageously provide granular (e.g., per-second) income distribution, real-time access to income, smoothed income variability, integration with third party tools (e.g., accounting software), timely payment to third parties, among other things.

It will be understood that the example workflow 700 may include additional, fewer, and/or alternate steps.

### Management Platform Dashboard

The management platform may include a dashboard to manage income streams corresponding to soulbound tokens. A user may access the dashboard in a manner similar to accessing the management platform, for example a computing device, a management platform client application, via a website/portal, etc. For example, via the dashboard, the management platform user (e.g., the income recipient, the company providing retirement services) may onboard income streams, create and mint soulbound tokens, create and deploy smart contracts, view income stream information (analytics, historical information, real-time information, etc.), manage income distributions, receive financial insights (e.g., income forecasting, income modeling), configure alerts, receive notifications, among other things. The dashboard may integrate with third-party systems and software (e.g., distributed ledgers, accounting software). Advantageously, the dashboard provides a centralized view of income streams and associated details, as well as other information and functionality, to provide income stream management.

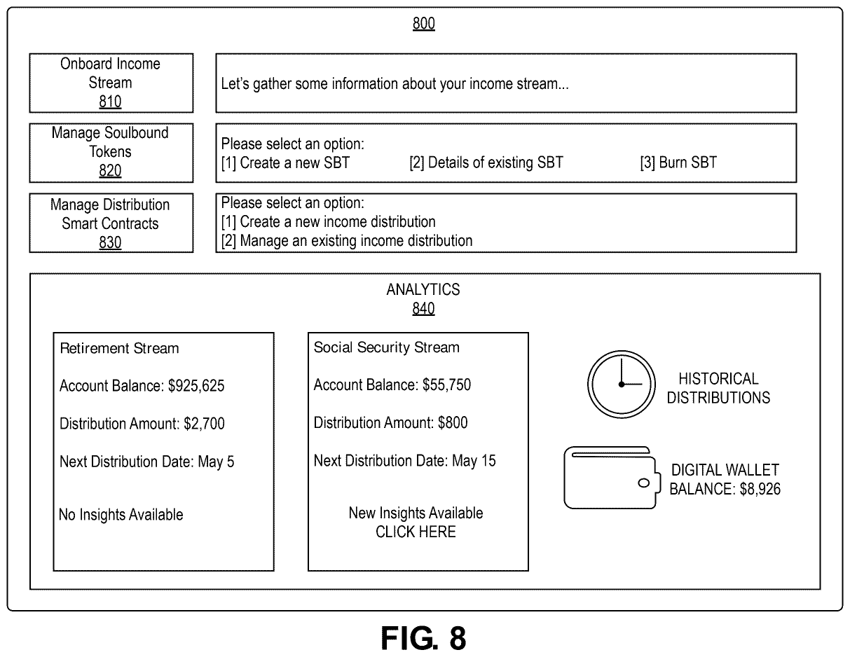

FIG. 8 depicts an example income stream dashboard 800, configured to perform at least a portion of the steps of the workflow 700. The dashboard 800 may provide functionality to onboard income streams 810, manage soulbound tokens 820, and manage smart contracts for income distribution 830. The dashboard 800 may include income stream analytics 840. The information provided by the dashboard 800 may be updated in real-time.

To onboard income streams 810, the dashboard 800 may collect the income stream information, as described with respect to 710, from the user that is necessary to onboard the income stream. The dashboard 800 may provide the user, such as the income recipient, the ability to onboard income streams of their choosing. The dashboard 800 may also provide information associated with an onboarded income stream, for example via the analytics 840.

To manage soulbound tokens 820 associated with onboarded income streams 810, the dashboard 800 may provide the option to create the soulbound token associated with an onboarded income stream, for example for the onboarded income stream which does not already have an existing soulbound token. Creating the soulbound token via the dashboard 800 may include generating the code for the associated distributed ledger transaction, generating the transaction, and providing the transaction to a node of the distributed ledger for validation and recording on the distributed ledger. In at least some aspects, generating the code for the soulbound token may be performed by AI available through the dashboard 800. The dashboard 800 may provide the option to view details associated with existing soulbound tokens, such as the soulbound token title, soulbound token description, links to associated smart contracts, and/or any other suitable soulbound token information. The dashboard 800 may provide the option to destroy/burn the soulbound token, for example when the characteristics of the soulbound token allow burning of the soulbound token.

To manage smart contracts for income distribution 830, the dashboard 800 may provide the option to create new income distributions, or manage existing distributions. Managing smart contracts for income distribution 830 may include generating new smart contracts (e.g., capillary contracts) or editing exiting smart contracts, such as by generating new for an associated distributed ledger transaction. The dashboard 800 may further provide the transaction for the smart contract to a node of the distributed ledger for validation and recording on the distributed ledger. In at least some aspects, generating the code for the smart contract may be performed by AI available through the dashboard 800, as further described below.

The dashboard 800 may provide various analytics 840 associated with managing the income streams, such as an overview of onboarded income streams, income stream distribution information, income stream financial insights (e.g., AI-generated insights), historical income distributions, the digital wallet balance, and/or any other suitable information and analytics associated with managing the income stream.

In some examples, the user may wish to manage a retirement income stream via the dashboard 800. The user may select the onboard income stream 810 function by selecting the associated icon on the dashboard 800. Once selected, the dashboard may request income source information associated with the income stream, such as the type of income (e.g., retirement), the name of the business that is the income source, how often the income is received, the amount of income, how long the income will be provided, and user account information. In at least some aspects, the management platform providing the dashboard may verify aspects of the income source information, such as the income stream, for example using a third party credit reporting agency. The management platform may also verify the identity of the income recipient, whether the user or not, for example using an identity verification service. Once the income recipient and income stream are verified, the income stream may be onboarded.

The dashboard 800 may request the user provide information regarding a preferred distributed ledger, how the retirement income is to be distributed, such as the distribution amount, distribution frequency, distribution start and end dates, the digital wallet to distribute the funds into, trigger conditions which may cause a distribution to be performed etc. The dashboard may then generate code for a blockchain transaction including a smart contract configured to mint the soulbound token corresponding to the retirement income stream directly into a digital wallet, and automate income distribution according to the information provided by the user. The dashboard may act as a node to validate and record the transaction to mint the soulbound token in the digital wallet on the preferred distributed ledger, and automate the income distribution. The dashboard 800 may then provide (e.g., display) the analytics 840 associated with the retirement income stream (e.g., as described above).

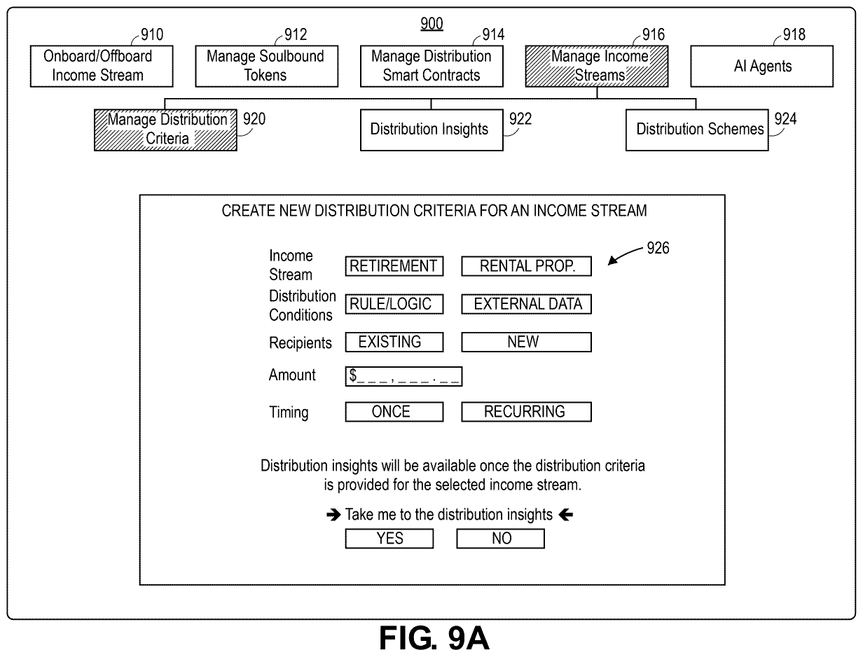

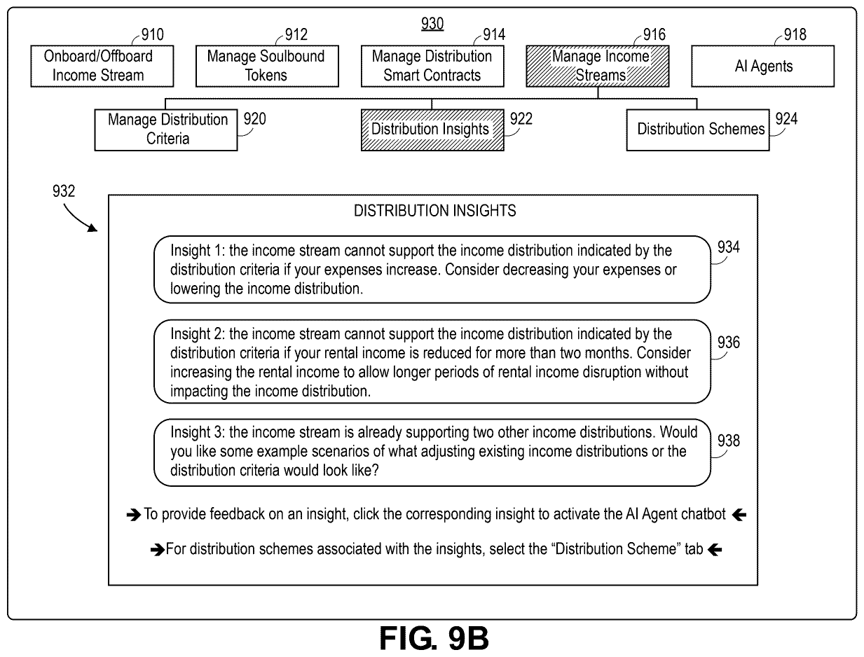

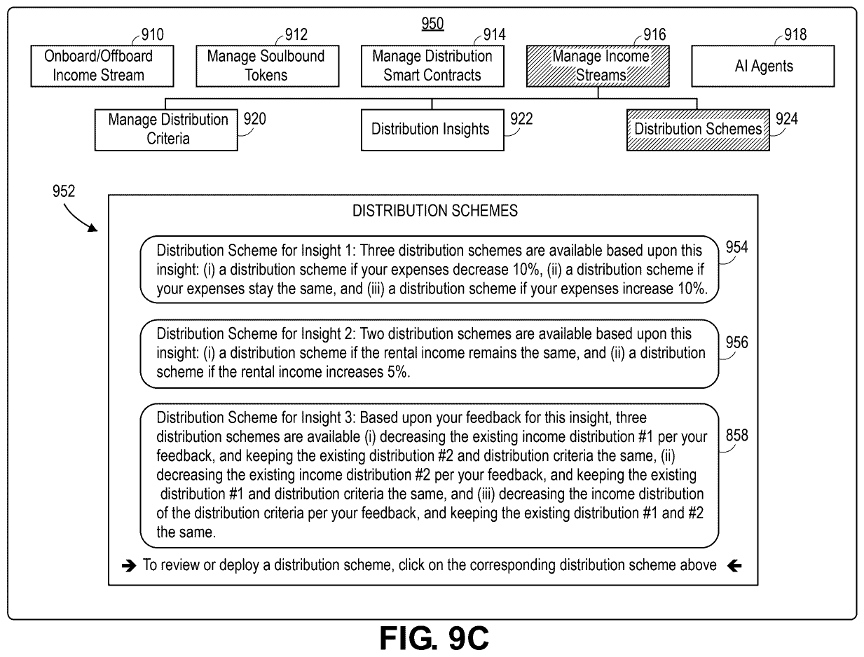

FIGS. 9A, 9B, and 9C depicts example income stream dashboards 900, 930, 950 respectively for managing income streams. The dashboards 900, 930, 950 may provide functionalities such as an onboard income streams feature 910, a manage soulbound tokens feature 912, a manage smart contracts feature 914, a manage onboarded income streams feature 916, and an interaction with AI agents feature 918, among other things.

A user, such as the owner/recipient of the income, a provider of retirement financial services, etc., may manage one or more income streams already onboarded into the management platform and/or represented on the distributed ledger as a soulbound token. Managing the income streams may include managing distribution criteria for distributing the income, managing distribution insights for income streams, and managing distribution schemes, among other things.

FIG. 9A illustrates the example income management platform dashboard 900 for providing income distribution criteria 926. The user may select the managing distribution criteria feature 920 for an income stream, such as a retirement income stream or a rental property income stream, which causes the dashboard 900 to display information associated with receiving the distribution criteria 926 from the user. The user is able to select an onboarded income stream associated with the distribution criteria. In at least some aspects, the management platform may mint a soulbound token associated with the onboarded income stream and record the soulbound token on the distributed ledger. The user can provide income distribution conditions for distributing the income, such as rules or logic representing distribution conditions. For example, the user may input conditions that result in an “if-then” rule indicating that if the balance of an account exceeds a certain amount, then an income distribution should be made. The distribution condition may be associated with external, off-chain, data that is integrated with the management platform, for example via application programming interfaces, data feeds, oracles, and/or other suitable manner. The distribution condition may be associated with the external data, for example external data used to trigger an income stream smart contract. The management platform, an oracle connects, or other source, may provide the external data to the distributed ledger, the blockchain and/or the smart contracts. In some examples, smart home sensors that monitor water, natural gas, and electricity usage in the user's home may provide their sensor data as external data to the blockchain. The user may select as distribution conditions that in winter months when excessive natural gas is used to heat the user's home, or in summer months when excessive electricity is used to air condition the home, income distributions to the user should be increased based upon the smart home sensors information to compensate for the increased costs of natural gas and electricity.

The dashboard 900 may provide the option to select one or more recipients of the income distribution, an income distribution amount, the timing of the distribution (e.g., one-time, recurring on a schedule, etc.) as distribution criteria, and and/or any other suitable distribution criteria.

The management platform may obtain information associated with the soulbound token corresponding to the income stream selected by the user for distributing income. The management platform (e.g., using AI agents) may generate one or more distribution insights using the soulbound token information and the distribution criteria. The management platform may use the soulbound token information to better understand aspects of the corresponding income stream that inform the distribution insights. The soulbound token information may include characteristics of the soulbound token (e.g., the soulbound token owner, the address of the digital wallet in which the soulbound token is located), characteristics of the corresponding income stream (e.g., the income source, the income amount, the income frequency), characteristics of smart contracts associated with the soulbound token (e.g., their function, conditions, or otherwise effect on the income from the stream), and/or any other suitable characteristic of the soulbound token as it relates to the income stream. The management platform may obtain the soulbound token information from the distributed ledger on which the soulbound token is located (e.g., the soulbound token code, metadata, etc.), from the user, from the income stream source, or from any other suitable source. In at least some aspects, the management platform may already have the soulbound token stored in a memory, for example when the management platform is used to generate the corresponding soulbound token, and/or smart contracts associated with the soulbound token, using previously provided soulbound token information.

FIG. 9B illustrates an example income management platform dashboard 930 for providing income distribution insights 932. The management platform (e.g., via the AI agent) may analyze the distribution criteria and the soulbound token information to generate the one or more income distribution insights 932, and provide the distribution insights 932 to the dashboard 930 via the distribution insights function 922. The distribution insights may include income analytics, income forecasting, financial goal modeling, financial advice, or an income distribution recommendation. For example, the distribution insight may include one or more suggestions of distribution criteria that will provide conservative or liberal approaches to distributing income, provide financial outlook insights based upon external financial data, and/or any other suitable distribution insight.

In some examples, through the analysis of the soulbound token information and the distribution criteria, the AI agent may determine the magnitude of income generated by the income stream and generate a first distribution insight 934 associated with whether the income stream income can support income distributions indicated by the user-provided distribution criteria, such as expenses and investments of the user.

In some examples, the AI agent may determine whether the income stream may experience a disruption in providing income (e.g., no rental property income when the property is without a tenant). The AI agent may generate a second distribution insight 936 associated with whether the income stream can support income distributions indicated by the distribution criteria if the income stream is disrupted. The distribution insights may indicate what effect an income disruption may have on the ability to provide income distributions, how long the income disruption could be tolerated without having a substantial effect on income distributions, and/or any other suitable distribution insight.

In some examples, the AI agent may understand how portions of the income are already being distributed based upon existing distributed ledger smart contracts for the income stream, and generate a third distribution insight 938 associated with whether the income can support the distributions indicated by the user-provided distribution criteria in light of the existing distributions. The distribution insights may indicate what effect changes to existing distribution and/or the new user-provided distribution criteria may have, or any other suitable distribution insight.

In at least some aspects, the user may provide feedback associated with the distribution insights. In some examples, the user may interact with the AI agent via a chatbot on the dashboards 900, 930, 950 to provide their feedback, and also receive responses, for example using the AI agent feature 918. In some examples, the feedback may include the user making a request to adjust their proposed distribution criteria based upon the distribution insights. In another example, the user feedback may include user questions associated with the distribution insights, such as requesting more information on the factors that informed the insight.

The management platform may provide one or more income distribution schemes to distribute the income to distribution recipients. In some embodiments, the AI agent generates the one or more distribution schemes based upon the one or more distribution insights. For example, the distribution criteria 926 may request the user's income be distributed among different categories such as savings, investments, expenses, and the associated distribution insights may indicate multiple financial priorities and goals impacted by how the income is distributed. The AI agent may generate one distribution scheme that prioritizes savings and investments, one distribution scheme that prioritizes investments only, and another which prioritized expenses, where each distribution scheme is reflective of a financial priority and/or goal provided by a corresponding distribution insight.

FIG. 9C illustrates an example income management platform dashboard 950 for providing income distribution schemes 952 based upon the distribution insights 932. The distribution schemes 952 include (i) a first set of three distribution schemes 954 based upon the first distribution insight 934, (ii) a second set of two distribution schemes 956 based upon the second distribution insight 936, and (iii) a third set of three distribution schemes 958 based upon the third distribution insight 938. The dashboard 950 allows the user to review the income distribution schemes 952 in more detail (e.g., the characteristics of the distribution scheme), and/or deploy a distribution scheme, for example using the AI agent to generate and deploy a smart contract implementing the distribution scheme, as previously described. The first set of distribution schemes 954 may include (i) a distribution scheme if the user's expenses decrease by a percentage (e.g., 5%, 10%, 25%, etc.), (ii) a distribution scheme if the user's expenses stay the same, and (iii) a distribution scheme if the user's expenses increase by a percentage (e.g., 5%, 10%, 25%, etc.). The second set of distribution schemes 956 may include (i) a distribution scheme if the user's rental income remains the same, and (ii) a distribution scheme if the rental income increases by a percentage (e.g., 5%, 10%, 25%, etc.). The third set of distribution schemes 958 may include (i) decreasing the existing income distribution #1 per the user's feedback, and keeping the existing distribution #2 and distribution criteria the same, (ii) decreasing the existing income distribution #2 per the feedback, and keeping the existing distribution #1 and distribution criteria the same, and (ii) decreasing the income distribution of the distribution criteria per the feedback, and keeping the existing distribution #1 and #2 the same.

The management platform may provide other information associated with managing income streams via its various functions, such as analytics associated income stream past performance, smart contract executed, predicted performance of income streams, external data information. In some aspects, the management platform may provide the analytics visually using graphs, charts, metrics, etc., via one or more dashboards, may use the AI agent to provide the analytics using natural language, may generate electronic report sent to the user, and/or any other suitable manner of providing analytics. In some aspects, the management platform may provide financial advice, for example via one or more AI agents trained to provide financial advice and accessible using the AI agents feature 918 of the management platform.

Although the example management platform and example dashboards 900, 930, 950 describe and provide various features, functionalities, and information, this is for illustration purposes and only, as the management platform and/or the dashboards 900, 930, 950 may provide more, less, and/or alternate features, functionalities, and information in accordance with the techniques described herein.

### Example Methods

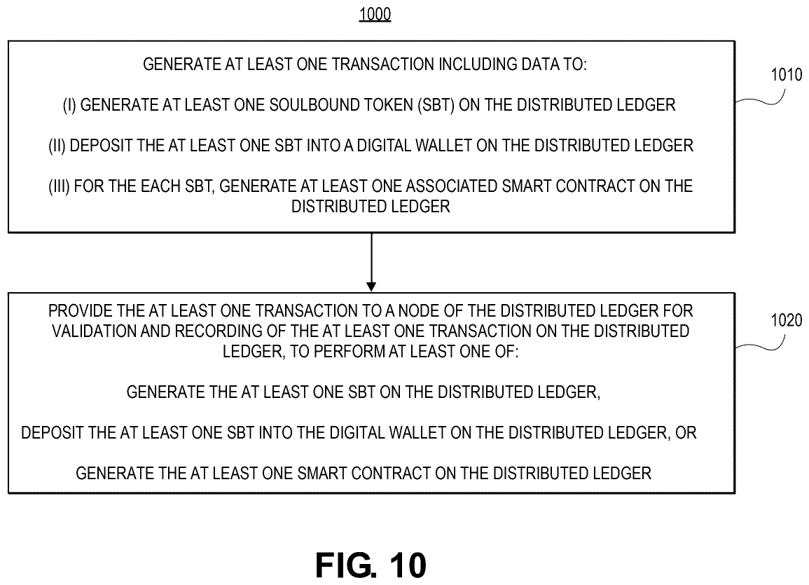

FIG. 10 illustrates a flow diagram of an example computer-implemented method 1000 for managing income streams using a distributed ledger. The computer-implemented method may be implemented, for example, using the computing environment 100.

The computer-implemented method 1000 may include generating, by one or more processors, at least one transaction including data to: (i) generate at least one soulbound token (soulbound token) on the distributed ledger, wherein each soulbound token of the at least one soulbound token is nontransferable and corresponds to an income stream providing an income from an income source, (ii) deposit the at least one soulbound token into a digital wallet on the distributed ledger associated with a recipient of the income, and (iii) for the each soulbound token, generate at least one associated smart contract on the distributed ledger, wherein each smart contract of the at least one smart contract is configured to automatically distribute at least a portion of the income, from the income stream of a corresponding soulbound token, into the digital wallet (block 1010). The soulbound token may be representative of at least one of: an income amount, an income distribution schedule, or recipient information. The smart contract may automatically distribute at least the portion of the income in response to at least one trigger condition, such as a time-based trigger, an event-based trigger, and a manual trigger. The smart contract may be configured to redistribute at least the portion of the income in the digital wallet to one or more redistribution recipients. The smart contract may be configured to perform at least one of: (i) minting the at least one soulbound token on the distributed ledger or (ii) depositing the at least one soulbound token into the digital wallet.

The computer-implemented method 1000 may include providing, by the one or more processors, the at least one transaction to a node of the distributed ledger for validation and recording of the at least one transaction on the distributed ledger, to perform at least one of: generating the at least one soulbound token on the distributed ledger, depositing the at least one soulbound token into the digital wallet on the distributed ledger, or generating the at least one smart contract on the distributed ledger (block 1020).

The computer-implemented method 1000 may include verifying the income stream, and/or verifying an identity of the recipient using decentralized identifier authentication. The income stream may be bound to a verified recipient via the soulbound token corresponding to the income stream.

The computer-implemented method 1000 may include an oracle configured to provide external data to the smart contract associated with the at least one condition.

The computer-implemented method 1000 may include generating a user interface, accessible via a computing device, and configured to manage at least one income stream. Managing at least one income stream may include performing one or more of: generating a soulbound token, recording the soulbound token on the distributed ledger, generating a smart contract, or recording the smart contract on the distributed ledger. The user interface may include one or more of: income source information, an income distribution amount, an income distribution frequency, distribution recipient information, a distribution amount, a distribution frequency, income analytics, or income forecasting. The information provided by the user interface may be updated in real-time.

It should be understood that not all blocks of the example flowchart of FIG. 10 are required to be performed. The example flowchart may include additional, less, or alternate functionality, including that discussed elsewhere herein.

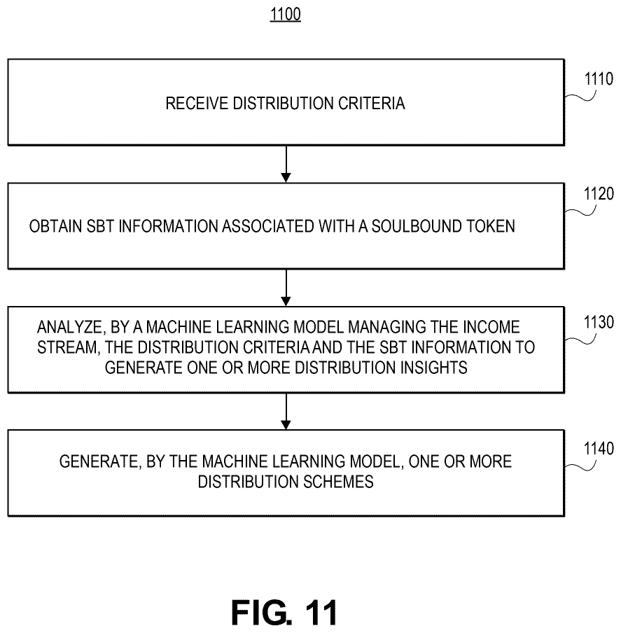

FIG. 11 illustrates a flow diagram of an example computer-implemented method 1100 for managing income streams using machine learning. The computer-implemented method 1100 may be implemented, for example, using the computing environment 100.

The computer-implemented method 1100 may include receiving, by one or more processors from a computing device, distribution criteria (block 1110). The distribution criteria may indicate criteria for distributing at least a portion of income received from an income stream to one or more distribution recipients. The distribution criteria may include a distribution condition, a distribution recipient, a distribution amount, distribution timing, and/or other suitable distribution criteria.

The computer-implemented method 1100 may include obtaining, by the one or more processors, soulbound token information associated with a soulbound token (block 1120). The soulbound token may be recorded on a distributed ledger and correspond to the income stream being managed using the computer-implemented method 1100. The soulbound token information may include characteristics of the soulbound token, characteristics of the corresponding income stream, characteristics of a smart contract associated with the soulbound token, and/or other suitable soulbound token information. The soulbound token information may include external data used to trigger the smart contract, such as economic data, income recipient health data, or income recipient environmental data, and/or other suitable data.

The computer-implemented method 1100 may include analyzing, by a machine learning model managing the income stream, the distribution criteria and the soulbound token information to generate one or more distribution insights (block 1130). The one or more distribution insights may include income analytics, income forecasting, financial goal modeling, financial advice, an income distribution recommendation, and/or other distribution insights. The machine learning model may be trained using historical financial data, such as historical income stream information, historical soulbound token information, historical distribution criteria, historical distribution insights, historical income distribution schemes, and/or any other suitable training data. In some aspects, the machine learning model may be trained using one computing device (e.g., the computing device 110), and executed on another computing device (e.g., the user computing device 140). In some aspects, the machine learning model may be trained and executed on the same computing device.

The computer-implemented method 1100 may include generating, by the machine learning model, one or more distribution schemes (block 1140). The one or more distribution schemes may be associated with distributing at least the portion of the income to the one or more distribution recipients. The machine learning model may generate the one or more distribution schemes based upon the one or more distribution insights. In at least some aspects of the computer-implemented method 1100, the one or more distribution schemes may include automatically depositing the income from the income stream into a digital wallet, and/or automatically distributing at least the portion of the income from the digital wallet to the one or more distribution recipients.

In at least some aspects, the computer-implemented method 1100 may include providing, by the one or more processors, the one or more distribution insights to the computing device, and receiving, by the one or more processors from the computing device, feedback associated with the one or more distribution insights used to generate the one or more distribution schemes.

In at least some aspects, the computer-implemented method 1100 may include generating, by the one or more processors, a user interface, accessible by the computing device, and configured to manage the income stream using the machine learning model.

In at least some aspects of the computer-implemented method 1100, the machine learning model is a chatbot, the computer-implemented method 1100 may include receiving, by the chatbot, a request to manage the income stream from the computing device; generating, by the chatbot, a response to the request; and providing, by the chatbot, the response to the computing device.

In at least some aspects of the computer-implemented method 1100, the income stream is a first income stream, the distribution criteria is a first distribution criteria, and the machine learning model is a first machine learning model. In such aspects, the computer-implemented method 1100 may include managing, via the second machine learning model, a second income stream based upon second distribution criteria. In such aspects, the first machine learning model and the second machine learning model may collaborate with one another to manage the first income stream and the second income stream.

In at least some aspects, the computer-implemented method 1100 may include retraining, by the one or more processors, the machine learning model using a plurality of training datasets associated with a plurality of financial domains, to generate a plurality of fine-tuned machine learning models trained to generate one or more domain insights associated with the respective plurality of financial domains; storing, by the one or more processors, the plurality of fine-tuned machine learning models in a memory; identifying, by the one or more processors, one or more fine-tuned machine learning models, of the plurality of fine-tuned machine learning models, based upon at least one of the distribution criteria or the soulbound token information; and using, by the one or more processors, the identified one or more fine-tuned machine learning models as the machine learning model to generate the one or more distribution insights, wherein the one or more distribution insights include at least one of the one or more domain insights.

In at least some aspects, the computer-implemented method 1100 may include generating, by the one or more processors, at least one transaction including data to generate at least one distribution smart contract associated with the soulbound token on the distributed ledger, the at least one distribution smart contract configured to execute the one or more distribution schemes; and providing, by the one or more processors, the at least one transaction to a node of the distributed ledger for validation and recording of the at least one transaction on the distributed ledger.

It should be understood that not all blocks of the example flowchart of FIG. 11 are required to be performed. The example flowchart may include additional, less, or alternate functionality, including that discussed elsewhere herein.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean.” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment may be included in at least some embodiments. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

1. A system for managing income streams using a distributed ledger, the system comprising:
one or more processors; and
one or more memories having stored thereon a set of computer-executable instructions that, when executed, cause the system to:
onboard, via a management platform, an income stream providing an income from an income source, the onboarding including verifying, via at least one machine learning model of the management platform:
(i) an identity of a recipient of the income stream using decentralized identifier authentication including one or more of: an ERC-1056 protocol or zero-knowledge proof, and
(ii) the income stream based upon information received from the recipient of the income stream via a machine learning chatbot;
responsive to verifying the identity and the income stream, transmit a transaction to a node of the distributed ledger that causes the node to:
(i) generate at least one soulbound token (SBT) on the distributed ledger, wherein each SBT of the at least one SBT is configured such that the each SBT:
is nontransferable once deposited into a particular digital wallet, and
corresponds to the income stream,
(ii) mint the at least one SBT on the distributed ledger by mapping metadata associated with the verified income stream to the SBT;
(iii) deposit the at least one SBT into a digital wallet on the distributed ledger associated with the recipient of the income, and
(iv) for the each SBT, generate at least one associated smart contract on the distributed ledger, wherein each smart contract of the at least one associated smart contract is configured to automatically distribute at least a portion of the income, from the income stream of a corresponding SBT, into the digital wallet.

2. The system of claim 1, wherein the at least one SBT is representative of at least one of: an income amount, an income distribution schedule, or recipient information.

3. (canceled)

4. The system of claim 1, wherein the income stream is bound to the verified recipient via the SBT corresponding to the income stream.

5. The system of claim 1, wherein the each smart contract automatically distributes at least the portion of the income in response to at least one trigger condition.

6. The system of claim 5, wherein a trigger condition is selected from the group consisting of a time-based trigger, an event-based trigger, and a manual trigger.

7. The system of claim 5, further comprising an oracle configured to provide external data to the smart contract associated with the at least one condition.

8. The system of claim 1, wherein the at least one smart contract is configured to redistribute at least the portion of the income in the digital wallet to one or more redistribution recipients.

9. The system of claim 1, further comprising instructions that, when executed, cause the system to:
generate a user interface, accessible via a computing device, and configured to manage at least one income stream.

10. The system of claim 9, further comprising instructions that, when executed, cause the system to:
manage the at least one income stream by performing one or more of: generating an SBT, recording the SBT on the distributed ledger, generating a smart contract, or recording the smart contract on the distributed ledger.

11. The system of claim 9, wherein the user interface includes one or more of: income source information, an income distribution amount, an income distribution frequency, distribution recipient information, a distribution amount, a distribution frequency, income analytics, or income forecasting.

12. The system of claim 9, wherein information provided by the user interface is updated in real-time.

13. The system of claim 1, wherein the at least one smart contract is further configured to perform at least one of: (i) minting the at least one SBT on the distributed ledger or (ii) depositing the at least one SBT into the digital wallet.

14. A computer-implemented method for managing income streams using a distributed ledger, the method comprising:
onboarding, by one or more processors via a management platform, an income stream providing an income from an income source, the onboarding including verifying, via at least one machine learning model of the management platform:
(i) an identity of a recipient of the income stream using decentralized identifier authentication including one or more of: an ERC-1056 protocol or zero-knowledge proof, and
(ii) the income stream based upon information received from the recipient of the income stream via a machine learning chatbot;
responsive to verifying the identity and the income stream, transmitting a transaction to a node of the distributed ledger that causes the node to:
(i) generate at least one soulbound token (SBT) on the distributed ledger, wherein each SBT of the at least one SBT is configured such that the each SBT:
is nontransferable once deposited into a particular digital wallet, and corresponds to the income stream,
(ii) mint the at least one SBT on the distributed ledger by mapping metadata associated with the verified income stream to the SBT;
(iii) deposit the at least one SBT into a digital wallet on the distributed ledger associated with the recipient of the income, and
(iv) for the each SBT, generate at least one associated smart contract on the distributed ledger, wherein each smart contract of the at least one associated smart contract is configured to automatically distribute at least a portion of the income, from the income stream of a corresponding SBT, into the digital wallet.

15. The computer-implemented method of claim 14, wherein the at least one SBT is representative of at least one of: an income amount, an income distribution schedule, or recipient information.

16. (canceled)

17. The computer-implemented method of claim 14, wherein the each smart contract automatically distributes the at least a portion of the income in response to at least one condition.

18. The computer-implemented method of claim 17, further comprising an oracle configured to provide external data to the smart contract associated with the at least one condition.

19. The computer-implemented method of claim 14, further comprising:
generating, by the one or more processors, a user interface, accessible via a computing device, and configured to manage at least one income stream.

20. A non-transitory computer-readable medium storing processor-executable instructions for managing income streams using a distributed ledger that, when executed by one or more processors, cause the one or more processors to at least:
onboard, via a management platform, an income stream providing an income from an income source, the onboarding including verifying, via at least one machine learning model of the management platform:
(i) an identity of a recipient of the income stream using decentralized identifier authentication including one or more of: an ERC-1056 protocol or zero-knowledge proof, and
(ii) the income stream based upon information received from the recipient of the income stream via a machine learning chatbot;
responsive to verifying the identity and the income stream, transmit a transaction to a node of the distributed ledger that causes the node to:
(i) generate at least one soulbound token (SBT) on the distributed ledger, wherein each SBT of the at least one SBT is configured such that the each SBT:
is nontransferable once deposited into a particular digital wallet, and corresponds to the income stream,
(ii) mint the at least one SBT on the distributed ledger by mapping metadata associated with the verified income stream to the SBT;
(iii) deposit the at least one SBT into a digital wallet on the distributed ledger associated with the recipient of the income, and
(iv) for the each SBT, generate at least one associated smart contract on the distributed ledger, wherein each smart contract of the at least one associated smart contract is configured to automatically distribute at least a portion of the income, from the income stream of a corresponding SBT, into the digital wallet.

21. The system of claim 1, wherein to generate the at least one SBT further comprises instructions that, when executed, cause the system to:
receive, from the recipient of the income via the management platform, one or more conditions for destroying the at least one SBT; and
provide, to a machine learning model of the management platform, the one or more conditions for destroying the at least one SBT causing the machine learning model to generate code configuring the at least one SBT to be destroyed based upon the one or more conditions.

22. The computer-implemented method of claim 14, wherein generating the at least one SBT further comprises:
receiving, by the one or more processors from the recipient of the income via the management platform, one or more conditions for destroying the at least one SBT; and
providing, by the one or more processors to a machine learning model of the management platform, the one or more conditions for destroying the at least one SBT causing the machine learning model to generate code configuring the at least one SBT to be destroyed based upon the one or more conditions.
